(19) United States
(12) Patent Application Publication
(10) Pub. No.: US 2026/0337116 A1
(43) Pub. Date: Oct. 29, 2026

(54) CERAMIC GREEN-BODIES, METHOD OF MAKING SINTERED ARTICLES, AND A SOLVENT-ANNEALING APPARATUS

(71) Applicant: CORNING INCORPORATED, CORNING, NY (US)

(72) Inventors: William Joseph Bouton, Big Flats, NY (US); Dane Alphanso Christie, Painted Post, NY (US); Andrew Fleitz Husted, Wellsburg, NY (US)

(21) Appl. No.: 19/101,549

(22) PCT Filed: Aug. 16, 2023
(86) PCT No.: PCT/US2023/030303

§ 371 Date: Feb. 5, 2025

Related U.S. Application Data
(60) Provisional application No. 63/400,488, filed on Aug. 24, 2022.
(60) Provisional application No. 63/470,598, filed on Jun. 2, 2023.

(51) Int. Cl. C04B 35/638; C04B 35/01; C04B 35/626; C04B 35/634; C04B 35/64; H01M 4/04

(52) U.S. Cl. CPC C04B 35/638; C04B 35/01; C04B 35/6264; C04B 35/62655; C04B 35/62675; C04B 35/63464; C04B 35/64; H01M 4/0471; C04B 2235/3275; C04B 2235/5445; C04B 2235/6027; C04B 2235/6567

(57) ABSTRACT

Ceramic green-bodies include from about 5 wt % to about 20 wt % of a carbonate-based polymer, from about 70 wt % to about 95 wt % of alkali-metal containing ceramic particles, from 0 wt % to about 5 wt % of a dispersant, and from 0 wt % to about 5 wt % of a viscosity modifier. Methods include heating a ceramic green-body at about 300 °C or less for about 4 minutes or less to remove about 70 wt % or more of organic materials in the ceramic green-body. The sintered article includes a relative density of about 90% or more of a theoretical density. The ceramic green-body includes a carbonate-based polymer and alkali-metal containing ceramic particles. Solvent annealing apparatus include a casting chamber, a solvent-laden chamber, and a drying chamber. Methods include casting a green-body in an environment with a vapor pressure of about 1000 Pascals or more of a solvent in the green-body.

This application claims the benefit of priority under 35 U.S.C. § 119 of U.S. Provisional Application Ser. No. 63/470,598 filed on Jun. 2, 2023, and U.S. Provisional Application Ser. No. 63/400,488 filed on Aug. 24, 2022, the content of which is relied upon and incorporated herein by reference in its entirety.

### FIELD

The present disclosure relates to solvent-annealing apparatus, method of using solvent-annealing apparatus, ceramic green-bodies, sintered articles, and methods of making the same, and more particularly to solvent-annealing apparatus comprising a solvent-laden chamber, ceramic green-bodies comprising a carbonate-based polymer, sintered articles made from the ceramic green-bodies, and methods of making the same.

### BACKGROUND

Sintered ceramic articles can be used in batteries (e.g., cathode, solid-state electrolyte) or as a protective cover for a consumer electronic device. It is known to form sintered ceramic articles by heating a ceramic green-body to remove organic material followed by sintering. It is known to use poly(vinyl butyral) to form a ceramic green-body. However, the processing of a ceramic green-body with poly(vinyl butyral) is limited by a heating rate that can produce a high-quality sintered article. Consequently, there is a need to develop alternative formulations for ceramic green-bodies that can be used to form a sintered article at faster processing rates.

### SUMMARY

The present disclosure provides a ceramic green-body comprising a carbonate-based polymer, a sintered article formed from the ceramic-green body, and methods of making the same. Providing a carbonate-based polymer can enable faster processing of the resulting ceramic green-body to form the sintered article, for example, by decreasing the incidence of events during heating the ceramic green-body that can impair the quality of the sintered article. For example, the carbonate-based polymer can provide reduced flammability during heating of the ceramic green-body. Flammability is associated with relatively large molecular weights (e.g., 200 Daltons or more) corresponding to multiple monomers bonded together, which can be produced during heating, for example, as a result of decomposition by chain scission. Without wishing to be bound by theory, carbonate-based polymers and acrylate-based (e.g., methacrylate-based) polymers can decompose by depolymerization in addition to chain scission while other polymers only decompose by chain scission. However, as demonstrated in the Examples below, in the presence of alkali-metal containing ceramic particles, it has unexpectedly been found that methacrylate-based polymers predominantly decompose by chain scission while carbonate-based polymers predominantly decompose by depolymerization. Without wishing to be bound by theory, alkali-metal containing ceramic particles can present issues for debinding (i.e., removing organic components of the ceramic green-body) in a short period of time (e.g., about 4 minutes or less) because the alkali metals can catalyze chain scission of components (e.g., polymers) of the binder system that can be flammable, which can damage the ceramic and/or the resulting sintered article. Providing a reduced heat flow (e.g., about 7 W/g of the ceramic green-body or less, about 2 W/g of the polymer in the ceramic green-body) can reduce an incidence of defects introduced during heating, for example from run-away thermal decomposition or flammability of the polymer decomposing, and/or enable faster processing of the ceramic green-body while maintaining high quality of the resulting sintered article.

Heating the alkali-metal containing ceramic particles before mixing and/or casting the ceramic green-body can volatilize materials absorbed onto the alkali-metal containing ceramic particles and/or reduce an amount of alkali-metal at a surface of the alkali-metal containing ceramic particles. Mixing the alkali-metal containing ceramic particles with a solvent and optionally a dispersant (e.g., without additional materials) can provide a good dispersion of the alkali-metal containing ceramic particles in the solvent with few or no aggregates, which can improve a dispersion and/or distribution of the alkali-metal containing ceramic particles during subsequent steps of the methods. As discussed above, providing the dispersant can improve a dispersion and/or distribution of the alkali-metal containing ceramic particle and/or increase a period of time while the dispersion of the alkali-metal containing ceramic particles can be maintained. The carbonate-based polymer can enable increased processing speed (e.g., faster debinding of the resulting ceramic green-body) and/or increased quality of the resulting sintered article. Providing the viscosity modifier can enable a predetermined viscosity of the second mixture to be obtained, which can enable casting the ceramic green-body while simultaneously enabling the ceramic green-body to be dimensionally stable. Providing a solvent-containing reduced pressure environment can reduce a loss of solvent from the second mixture during deairing to form the precursor mixture. Providing a reduced pressure environment can reduce dissolved gasses in the second mixture to provide a precursor mixture that can be formed into a ceramic green-body with uniform, high-quality surfaces. Using solvent annealing can produce a higher quality ceramic green-body with reduced defects that can be used to form a higher quality sintered article with reduced defects than would be obtained without solvent annealing. In aspects, the first oven 603 can the second oven 605 can connect and/or abut one another such that a temperature of the debound ceramic article 201 does not drop significantly (e.g., about 100 °C or less, about 50 °C or less), which can reduce energy costs, reduce processing time, and/or reduce space required for processing.

The present disclosure also presents a solvent-annealing apparatus including a solvent-laden chamber configured to control a rate of solvent removal from the solvent-containing ceramic green-body. Using solvent annealing can produce a higher quality ceramic green-body with reduced defects that can be used to form a higher quality sintered article with reduced defects than would be obtained without solvent annealing. Providing a casting vapor pressure (e.g., about 100 Pascals or more, from about 1,000 Pascals to about 50,000 Pascals, and/or within 10,000 Pascals of the vapor pressure at the boiling point of the solvent) of solvent in a casting chamber can limit an amount of solvent evaporating from the solvent-containing ceramic green-body during casting and/or in the casting chamber, which can be associated with a good surface quality of the resulting solvent-free ceramic green-body and/or sintered article. Providing a chamber vapor pressure (e.g., about 20 Pascals or more, from about 1,000 Pascals to about 50,000 Pascals, and/or less than the casting vapor pressure) of the solvent in the solvent-laden chamber can facilitate the controlled removal of solvent from the solvent-containing ceramic green-body. Providing an increasing temperature encountered by the solvent-containing ceramic green-body being transported through the solvent-laden ceramic green-body can facilitate the controlled and continuous removal of solvent from solvent-laden ceramic green-body as part of the solvent-annealing process. Providing a drying vapor pressure less of about 20 Pascals or less in the drying chamber can facilitate the removal of solvent from the solvent-containing ceramic green-body to form the solvent-free ceramic green-body. Providing an inlet at the distal end and an outlet at the proximate end of the drying chamber enables the atmosphere to flow in a direction opposite the direction that the solvent-containing ceramic green-body is transported, which can enable the atmosphere continuously remove solvent from the solvent-containing ceramic green body as the atmosphere flows by the solvent-containing ceramic green body and/or through the drying chamber. Additionally, providing the outlet at the proximate end of the drying chamber can enable the any solvent from the environment of the solvent-laden chamber that passes through the orifice 1329 to be removed. Introducing atmosphere at both the distal end and at another location (between the distal end and the proximate end) can facilitate removal of solvent from the solvent-containing ceramic green-body at a predetermined rate. Providing a low average speed of atmosphere (e.g., about 0.1 m/s or less, or from about 0.01 m/s to about 0.1 m/s) over the solvent-containing ceramic green body can facilitate uniform drying and/or good surface quality of the resulting solvent-free ceramic green-body and/or resulting sintered article. The average speed of atmosphere over the solvent-containing ceramic green-body can be less than an average speed of atmosphere at other locations in the drying chamber, which can facilitate high surface quality of the resulting article while exchanging larger amounts of atmosphere through the drying chamber 1331 to keep the chamber vapor pressure low.

Some example aspects of the disclosure are described below with the understanding that any of the features of the various aspects may be used alone or in combination with one another.

Aspect 1. A ceramic green-body, as a wt % of a solvent-free ceramic green-body, comprising:
from about 5 wt % to about 20 wt % of a carbonate-based polymer;
from about 70 wt % to about 95 wt % of alkali-metal containing ceramic particles;
from 0 wt % to about 5 wt % of a dispersant; and
from 0 wt % to about 5 wt % of a viscosity modifier.

Aspect 2. The ceramic green-body of aspect 1, where the alkali-metal containing ceramic particles are lithium-containing ceramic particles.

Aspect 3. The ceramic green-body of aspect 2, wherein the lithium-containing ceramic particles comprise lithium cobalt oxide, lithium manganese oxide, lithium nickel manganese cobalt oxide, lithium nickel cobalt aluminum oxide, lithium iron phosphate, or combinations thereof.

Aspect 4. The ceramic green-body of any one of aspects 1-3, wherein the carbonate-based polymer consists of alkyl carbonate esters.

Aspect 5. The ceramic green-body of any one of aspects 1-4, wherein the carbonate-based polymer consists of poly(ethylene carbonate), poly(propylene carbonate), poly(butylene carbonate), poly(cyclohexene carbonate), poly(propylene carbonate-co-cyclohexene carbonate), poly(propylene-co-cyclohexene carbonate), or combinations thereof.

Aspect 6. The ceramic green-body of any one of aspects 1-5, wherein the viscosity modifier comprises a dibutyl carboxylic acid ester.

Aspect 7. The ceramic green-body of any one of aspects 1-5, wherein the viscosity modifier comprises dibutyl phthalate, dibutyl adipate, dibutyl maleate, poly(ethylene glycol), or combinations thereof.

Aspect 8. The ceramic green-body of any one of aspects 1-7, wherein a thickness of the solvent-free ceramic green-body ranges from about 5 micrometers to about 100 micrometers.

Aspect 9. The ceramic green-body of any one of aspects 1-8, wherein a median particle size of the alkali-metal containing ceramic particles is about 0.5 micrometers or less.

Aspect 10. The ceramic green-body of any one of aspects 1-9, wherein a ratio of a weight of the solvent-free ceramic green-body to a weight of a solvent-containing ceramic green-body is from about 0.5 to about 0.7.

Aspect 11. A method of forming a sintered article:
heating a ceramic green-body at a maximum temperature of about 300 °C or less for a first period of time of about 4 minutes or less, the heating removes about 70 wt % or more of organic materials in the ceramic green-body; and then
sintering the ceramic green-body at a second temperature from about 700 °C to about 1500 °C for a second period of time from about 30 minutes to about 5 hours to form the sintered article, the sintered article comprising a relative density of about 90% or more of a theoretical density,
wherein the ceramic green-body comprises a carbonate-based polymer and alkali-metal containing ceramic particles.

Aspect 12. The method of aspect 11, wherein the heating removes about 90% or more of organic materials in the ceramic green-body.

Aspect 13. The method of any one of aspects 11-12, wherein the maximum temperature is about 260 °C or less and the first period of time is about 1 minute or less.

Aspect 14. The method of any one of aspects 11-13, wherein a maximum heat flow from the ceramic green-body during the heating, in Watts per gram of a polymer in the ceramic green-body (W/g), is about 2 W/g or less.

Aspect 15. The method of any one of aspects 11-14, wherein a thickness of the solvent-free ceramic green-body ranges from about 5 micrometers to about 100 micrometers.

Aspect 16. The method of any one of aspects 11-15, wherein the ceramic green-body, as a wt % of a solvent-free ceramic green-body, comprising:
from about 5 wt % to about 20 wt % of the carbonate-based polymer;
from about 70 wt % to about 95 wt % of the alkali-metal containing ceramic particles;
from 0 wt % to about 5 wt % of a dispersant; and
from 0 wt % to about 5 wt % of a viscosity modifier.

Aspect 17. The method of aspect 16, wherein the viscosity modifier comprises a dibutyl carboxylic acid ester.

Aspect 18. The method of any one of aspects 11-15, further comprising:
casting a solvent-containing ceramic green-body from a precursor mixture, the solvent-containing ceramic green-body comprising an initial thickness from about 5 micrometers to about 100 micrometers; and
solvent annealing the solvent-containing ceramic green-body to obtain a solvent-free ceramic green-body.

Aspect 19. The method of aspect 18, wherein a ratio of a weight of the solvent-free ceramic green-body to a weight of the solvent-containing ceramic green-body is from about 0.5 to about 0.7.

Aspect 20. The method of any one of aspects 18-19, further comprising:
mixing the alkali-metal containing ceramic particles with a solvent and optionally a dispersant to form a first mixture;
mixing the first mixture with the carbonate-based polymer and optionally a viscosity modifier to form a second mixture; and
deairing the second mixture in a reduced pressure environment for about 5 minutes or more to form the precursor mixture.

Aspect 21. The method of any one of aspects 18-19, wherein the solvent-annealing comprises:
maintaining the solvent-containing ceramic green-body in a solvent-laden chamber comprising a solvent in the solvent-containing ceramic green-body, a chamber vapor pressure of the solvent in the solvent-laden chamber is about 20 Pascals or more, the solvent-laden chamber maintained at a chamber temperature of 40 °C or more; and
drying the solvent-containing ceramic green-body in a drying chamber with a drying vapor pressure of the solvent-laden chamber is about 20 Pascals or less and drying temperature of about 70 °C or more.

Aspect 22. The method of aspect 21, wherein the chamber vapor pressure of the solvent in the solvent-laden chamber is from about 100 Pascals to about 50,000 Pascals.

Aspect 23. The method of any one of aspects 21-22, wherein the drying temperature is within about 20 °C of a boiling point of the solvent.

Aspect 24. The method of any one of aspects 21-23, wherein the casting the solvent-containing ceramic green-body occurs in a casting chamber comprising a casting vapor pressure that is greater than or equal to the chamber vapor pressure of the solvent-laden chamber.

Aspect 25. The method of any one of aspects 11-24, wherein the alkali-metal containing ceramic particles are lithium-containing ceramic particles.

Aspect 26. The method of any one of aspects 11-25, wherein a median particle size of the alkali-metal containing ceramic particles is about 0.5 micrometers or less.

Aspect 27. A solvent-annealing apparatus comprising:
a casting chamber comprising a casting apparatus configured to form a solvent-containing ceramic green-body from a precursor mixture, the casting chamber in fluid communication with a solvent reservoir;
a solvent-laden chamber comprising at least one heating apparatus configured to maintain a temperature of the solvent-laden chamber; and
a drying chamber comprising a ventilation system configured to circulate an atmosphere from a substantially solvent-free environment through the drying chamber,
wherein the solvent-laden chamber positioned between the casting chamber and the drying chamber, the solvent-laden chamber separated from the drying chamber by a baffle.

Aspect 28. The solvent-annealing apparatus of aspect 27, wherein a casting vapor pressure in the casting chamber of a solvent in the solvent-containing ceramic green-body is configured to be greater than or equal to a chamber vapor pressure in the solvent-laden chamber of the solvent, and the chamber vapor pressure is configured to be greater than a drying vapor pressure of the solvent in the drying chamber.

Aspect 29. The solvent-annealing apparatus of any one of aspects 27-28, wherein the ventilation system is configured to introduce the atmosphere from the substantially solvent-free environment at least at a distal end of the drying chamber opposite a proximate end of the drying chamber with the baffle, and the ventilation system is configured to remove the atmosphere from the drying chamber at the proximate end of the drying chamber.

Aspect 30. The solvent-annealing apparatus of aspect 29, wherein the drying chamber comprises a plurality of orifices, the plurality of orifices comprising a first orifice at the distal end of the drying chamber and at least an additional orifice between the distal end and the proximate end, the first orifice and the at least the additional orifice configured to introduce the atmosphere from the substantially solvent-free environment.

Aspect 31. The solvent-annealing apparatus of any one of aspects 27-30, wherein the solvent-laden chamber comprises at least one additional source of solvent.

Aspect 32. A method of forming a solvent-free ceramic green-body comprising: casting a solvent-containing ceramic green-body from a precursor mixture, the casting occurs in a casting chamber comprising a casting vapor pressure of about 100 Pascals or more of a solvent in the solvent-containing ceramic green-body;
transporting the solvent-containing ceramic green-body from the casting chamber to a solvent-laden chamber, the solvent-laden chamber comprising a chamber vapor pressure of the solvent in the solvent-laden chamber is about 20 Pascals or more, the casting vapor pressure is greater than or equal to the casting vapor pressure;
heating the solvent-containing ceramic green-body at a chamber temperature of the solvent-laden chamber of about 40 °C or more, the chamber temperature of the solvent-laden chamber is greater than a temperature of the casting chamber;
transporting the solvent-containing ceramic green-body from the solvent-laden chamber to a drying chamber, the chamber vapor pressure is greater than a drying vapor pressure of the solvent in the drying chamber; and
heating the solvent-containing ceramic green-body at a drying temperature of the drying chamber to form the solvent-free ceramic green-body, the drying temperature is greater than the chamber temperature.

Aspect 33. The method of aspect 32, wherein the casting vapor pressure is maintained by solvent reservoir of the solvent in fluid communication with the casting chamber, heating the solvent reservoir at a reservoir temperature greater than a casting temperature of the casting chamber.

Aspect 34. The method of aspect 33, wherein the reservoir temperature is from about 50 °C to about 95 °C.

Aspect 35. The method of any one of aspects 32-34, wherein the casting vapor pressure is from about 1,000 Pascals to about 50,000 Pascals.

Aspect 36. The method of any one of aspects 32-35, wherein the heating the solvent-containing ceramic green-body at the chamber temperature of the solvent-laden chamber occurs for from about 3 minutes to about 10 minutes.

Aspect 37. The method of any one of aspects 32-35, further comprising introducing an atmosphere from a substantially solvent-free environment into the drying chamber at least at a distal end and removing the atmosphere from the drying chamber at a proximate end at an interface between the solvent-laden chamber and the drying chamber, and the proximate chamber opposite the distal end.

Aspect 38. The method of aspect 37, wherein an average speed of the atmosphere over the solvent-containing ceramic green-body in the drying chamber is from about 0.01 meter per second to about 0.1 meters per second.

Aspect 39. The method of any one of aspects 37-38, wherein the introducing the atmosphere occurs at the distal end and at least an additional location between the distal end and the proximate end.

Aspect 40. The method of any one of aspects 32-39, wherein the solvent comprises propylene glycol, methyl ethyl ketone, dimethyl carbonate, toluene, or combinations thereof.

Aspect 41. The method of any one of aspects 32-40, wherein the solvent-containing ceramic green-body comprising an initial thickness from about 5 micrometers to about 100 micrometers.

Aspect 42. The method of any one of aspects 32-41, wherein the solvent-free ceramic green-body comprises:
from about 5 wt % to about 20 wt % of a carbonate-based polymer;
from about 70 wt % to about 95 wt % of alkali-metal containing ceramic particles;
from 0 wt % to about 5 wt % of a dispersant; and
from 0 wt % to about 5 wt % of a viscosity modifier.

### BRIEF DESCRIPTION OF THE DRAWINGS

The above and other features and advantages of aspects of the present disclosure are better understood when the following detailed description is read with reference to the accompanying drawings, in which:

FIG. 1 schematically illustrates a ceramic green-body in accordance with aspects of the disclosure;

FIG. 2 schematically illustrates a sintered article in accordance with aspects of the disclosure;

FIG. 3 illustrates heating alkali-metal containing ceramic particles as part of an exemplary method;

FIG. 4 illustrates mixing and deairing to form a precursor solution as part of an exemplary method;

FIG. 5 illustrates solvent annealing a ceramic green-body as part of an exemplary method;

FIG. 6 illustrates debinding and sintering as part of an exemplary method;

FIG. 7 is a flow chart illustrating example methods of forming a sintered article;

FIG. 8 illustrates mass-loss curves from thermo-gravimetric analysis (TGA);

FIG. 9 illustrates heat-flow curves from differential scanning calorimetry (DSC);

FIG. 10 illustrates mass-loss curves from TGA for poly(vinyl butyral) (PVB) and poly(propylene-co-cyclohexene carbonate) (PPCC) polymers;

FIG. 11 illustrates mass-loss curves from TGA for ceramic green-bodies;

FIG. 12 illustrates heat-flow curves from DSC for ceramic green-bodies;

FIG. 13 schematically illustrates a solvent-annealing apparatus; and

FIG. 14 is a cross-sectional view taken along line 14-14 of FIG. 13.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

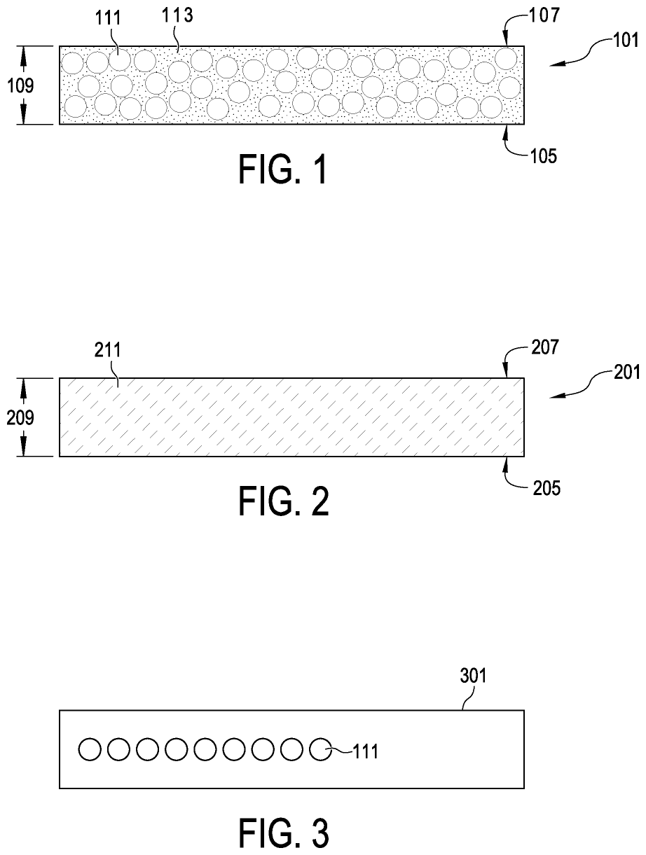

FIG. 1 illustrates a ceramic green-body 101 comprising a carbonate-based polymer and FIG. 2 illustrates a sintered article 201 that can be made from the ceramic green-body 101 in accordance with aspects of the disclosure. Unless otherwise noted, a discussion of features of aspects of one ceramic green-body can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

FIG. 1 illustrates a ceramic green-body 101 comprising a first major surface 105 and a second major surface 107 opposite the first major surface 105. In aspects, the first major surface 105 and/or the second major surface 107 can extend along a corresponding plane, and/or the first major surface 105 can be substantially parallel to the second major surface 107. A green-body thickness 109 is defined as an average distance between the first major surface 105 and the second major surface 107. In aspects, the green-body thickness 109 can be about 5 micrometers (μm) or more, about 10 μm or more, about 20 μm or more, about 30 μm or more, about 100 μm or less, about 80 μm or less, about 60 μm or less, or about 50 μm or less. In aspects, the green-body thickness 109 can range from about 5 μm to about 100 μm, from about 10 μm to about 80 μm, from about 20 μm to about 60 μm, from about 30 μm to about 50 μm, or any range or subrange therebetween.

As shown in FIG. 1, the ceramic green-body 101 comprises a plurality of ceramic particles 111 dispersed in a binder system 113. In aspects, the plurality of ceramic particles comprises alkali-metal containing ceramic particles. As used herein, “alkali metal” refers to lithium, sodium, potassium, rubidium, cesium, francium, or combinations thereof. Without wishing to be bound by theory, alkali-metal containing ceramic particles can present issues for debinding (i.e., removing organic components of the ceramic green-body) in a short period of time (e.g., about 4 minutes or less) because the alkali metals can catalyze chain scission of components (e.g., polymers) of the binder system that can be flammable, which can damage the ceramic and/or the resulting sintered article. In further aspects, the alkali-metal containing ceramic particles can comprise lithium-containing ceramic particles. Exemplar aspects of lithium-containing ceramics include lithium cobalt oxide, lithium manganese oxide, lithium nickel manganese cobalt oxide, lithium nickel cobalt aluminum oxide, lithium iron phosphate, or combinations thereof.

Throughout the disclosure, “particle size” of a ceramic particle is determined from direct imaging with a scanning electron microscope (SEM), where the largest dimension of the ceramic particle is taken as the particle size. In aspects, a median particle size of the alkali-metal containing ceramic particles can be about 10 μm or less, about 5 μm or less, about 2 μm or less, about 1 μm or less, or about 0.5 μm or less, for example, ranging from 0.01 μm to about 10 μm, from about 0.05 μm to about 5 μm, from about 0.1 μm to about 1 μm, from about 0.2 μm to about 0.5 μm, or any range or subrange therebetween.

Throughout the disclosure, “as a wt % of a solvent-free ceramic green-body” refers to a weight percentage (wt %) of the ceramic green-body ignoring any contributions from solvent. In aspects, the ceramic green-body, as a wt % of the solvent-free ceramic green-body, can comprise the alkali-metal containing ceramic particles in an amount of about 70 wt % or more, about 73 wt % or more, about 75 wt % or more, about 76 wt % or more, about 77 wt % or more, about 78 wt % or more, about 95 wt % or less, 93 wt % or less, about 90 wt % or less, about 85 wt % or less, about 84 wt % or less, about 83 wt % or less, or about 82 wt % or less. In aspects, the ceramic green-body, as a wt % of the solvent-free ceramic green-body, can comprise the alkali-metal containing ceramic particles in a range from about 70 wt % to about 95 wt %, from about 73 wt % to about 93 wt %, from about 75 wt % to about 90 wt %, from about 76 wt % to about 85 wt %, from about 77 wt % to about 84 wt %, from about 78 wt % to about 83 wt %, from about 78 wt % to about 82 wt %, or any range or subrange therebetween.

The binder system 113 comprises a carbonate-based polymer. As used herein, a “carbonate-based polymer” contains carbonate esters, which have a R1-O—C(O)—O—R2 structure, along the backbone of the repeat unit (i.e., monomer), where R1 and R2 can be organic groups. In aspects, R1 can be omitted with R2 comprising an organic group, for example, with the repeat unit extending from the left-most oxygen through R2, or vice versa with R2 omitted and R1 comprising an organic unit. Throughout the disclosure, an “organic group” consists of atoms selected from a group consisting of carbon, hydrogen, oxygen, nitrogen, sulfur, phosphor, chlorine, and bromine. In aspects, the carbonate-based polymer can consist of atoms selected from a group consisting of carbon, hydrogen, and oxygen. Throughout the disclosure, a “backbone” of a repeat unit refers to the longest chain of atoms that extends from a bond defining one end of the repeat unit to another bond defining the other end of the repeat unit. Throughout the disclosure, a “backbone” of a polymer refers to the longest chain of atoms extending from one end of the polymer to another end of the polymer. In aspects, the carbonate-based polymer can comprise a linear polymer. As used herein, a “linear polymer” comprises repeat units that are connected to only one or two other repeat units such that all of the repeat units form a continuous chain from one end of the polymer to the other.

In aspects, the carbonate-based polymer can comprise a homopolymer. As used herein, a “homopolymer” consists of a single repeat unit that is repeated to form the homopolymer. Exemplary aspects of homopolymer carbonate-based polymers include polycarbonate, poly(ethylene carbonate), poly(propylene carbonate), poly(butylene carbonate), poly(pentamethylene carbonate), poly(hexamethylene carbonate), poly(cyclopentene carbonate), and poly(cyclohexene carbonate). In further aspects, the binder system can consist of alkyl carbonate esters in the polymerized form of the repeat unit. As used herein, “alkyl” refers to unsaturated (i.e., without double bonds) functional groups consisting of combinations of carbon, hydrogen, and/or oxygen. For example, alkyl groups include linear C₁-C₂₀ compounds, cyclic C₅-C₁₀ compounds, and combinations thereof. An alkyl carbonate ester has no double bonds other than in the carbonate ester. Exemplary aspects of linear alkyl carbonate ester-based polymers include poly(ethylene carbonate), poly(propylene carbonate), poly(butylene carbonate), poly(pentamethylene carbonate), and poly(hexamethylene carbonate). Exemplary aspects of cyclic alkyl carbonate ester-based polymers include poly(cyclopentene carbonate) and poly(cyclohexene carbonate). In aspects, the carbonate-based polymer can comprise a copolymer. As used herein, a “copolymer” comprises two or more different repeat units (i.e., co-monomers) that are repeated to form the homopolymer. Copolymers can be block copolymers with distinct blocks for each repeat unit, alternating copolymers (e.g., A-B-A-B), or random copolymers. In aspects, one co-monomer comprises a carbonate ester and another co-monomer is an alkyl chain. In further aspects, one co-monomer comprises an alkyl carbonate ester and another co-monomer is an alkyl chain. Exemplary aspects of carbonate-based copolymers are poly(propylene carbonate-co-cyclohexene carbonate) and poly(propylene-co-cyclohexene carbonate). Exemplary aspects of carbonate-based polymers include poly(ethylene carbonate), poly(propylene carbonate), poly(butylene carbonate), poly(cyclohexene carbonate), poly(propylene carbonate-co-cyclohexene carbonate), poly(propylene-co-cyclohexene carbonate), or combinations thereof.

Providing a carbonate-based polymer can enable faster processing of the resulting ceramic green-body to form the sintered article, for example, by decreasing the incidence of events during heating the ceramic green-body that can impair the quality of the sintered article. For example, the carbonate-based polymer can provide reduced flammability during heating of the ceramic green-body. Flammability is associated with relatively large molecular weights (e.g., 200 Daltons or more) corresponding to multiple monomers bonded together, which can be produced during heating, for example, as a result of decomposition by chain scission. Without wishing to be bound by theory, carbonate-based polymers and acrylate-based (e.g., methacrylate-based) polymers can decompose by depolymerization in addition to chain scission while other polymers only decompose by chain scission. However, as demonstrated in the Examples below, in the presence of alkali-metal containing ceramic particles, it has unexpectedly been found that methacrylate-based polymers predominantly decompose by chain scission while carbonate-based polymers predominantly decompose by depolymerization.

Throughout the disclosure, the “molecular weight” of a polymer chain is measured by high-performance liquid chromatography (HPLC) calibrated using polystyrene (PS) standards. As used herein, “molecular weight” refers to the number average molecular weight (Mn). A number average molecular weight is calculated for a polymer by summing the products of a molecular weight and the fraction of polymers with that molecular weight. In aspects, the molecular weight (Mn) of the polycarbonate-based polymer (e.g., in the ceramic green-body) can be about 50,000 Daltons (Da) or more, about 100,000 Da or more, about 120,000 Da or more, about 500,000 Da or less, about 300,000 Da or less, about 250,000 Da or less, or about 200,000 Da or less, for example, in a range from about 50,000 Da to about 500,000 Da, from about 100,000 Da to about 300,000 Da, from about 100,000 Da to about 250,000 Da, or any range or subrange therebetween.

In aspects, the ceramic green-body, as a wt % of the solvent-free ceramic green-body, can comprise the carbonate-based polymer in an amount of about 5 wt % or more, about 10 wt % or more, about 12 wt % or more, about 15 wt % or more, about 20 wt % or less, about 19 wt % or less, about 18 wt % or less, or about 17 wt % or less. In aspects, the ceramic green-body, as a wt % of the solvent-free ceramic green-body, can comprise the carbonate-based polymer in a range from about 5 wt % to about 20 wt %, from about 10 wt % to about 19 wt %, from about 12 wt % to about 18 wt %, from about 15 wt % to about 17 wt %, or any range or subrange therebetween.

In aspects, the binder system 113 can comprise a dispersant. As used herein, a “dispersant” refers to a material that improves a separation of particles, improves a uniformity of a distribution of particles, decreases particle aggregation, and/or reduces settling of particles. In aspects, the dispersant can comprise a fish oil or commercial dispersants, for example, the Hypermer line of dispersants (available from Croda Energy Technologies). In aspects, the ceramic green-body, as a wt % of the solvent-free ceramic green-body, can comprise the dispersant in an amount of 0 wt % or more, greater than 0 wt % or more, about 0.5 wt % or more, about 1 wt % or more, about 1.1 wt % or more, about 1.2 wt % or more, about 5 wt % or less, about 3 wt % or less, about 2 wt % or less, or about 1.5 wt % or less, or about 1.3 wt % or less. In aspects, the ceramic green-body, as a wt % of the solvent-free ceramic green-body, can comprise the dispersant in a range from 0 wt % to about 5 wt %, from greater than 0 wt % to about 5 wt %, from about 0.5 wt % to about 3 wt %, from about 1 wt % to about 2 wt %, from about 1.1 wt % to about 1.5 wt %, from about 1.2 wt % to about 1.3 wt %, or any range or subrange therebetween. Alternatively, in aspects, the binder system 113 can be free from a dispersant.

In aspects, the binder system 113 can comprise a viscosity modifier. In aspects, a viscosity modifier can increase a viscosity of the resulting mixture. In aspects, the viscosity modifier can comprise a dibutyl carboxylic acid ester. Exemplary aspects of viscosity modifiers include dibutyl phthalate, dibutyl adipate, dibutyl maleate, poly(ethylene glycol), and combinations thereof. In further aspects, the viscosity modifier can comprise dibutyl phthalate. In aspects, the ceramic green-body, as a wt % of the solvent-free ceramic green-body, can comprise the viscosity modifier in an amount of 0 wt % or more, greater than 0 wt % or more, about 0.5 wt % or more, about 1 wt % or more, about 1.5 wt % or more, about 5 wt % or less, about 4 wt % or less, or about 3 wt % or less, about 2.5 wt % or less, or about 2 wt % or less. In aspects, the ceramic green-body, as a wt % of the solvent-free ceramic green-body, can comprise the viscosity modifier in a range from 0 wt % to about 5 wt %, from greater than 0 wt % to about 4 wt %, from about 0.5 wt % to about 3 wt %, from about 1 wt % to about 2.5 wt %, from about 1.5 wt % to about 2 wt %, or any range or subrange therebetween. Alternatively, in aspects, the binder system 113 can be free from a viscosity modifier.

In aspects, the ceramic green-body can comprise a solvent. For example, the ceramic green-body can be formed from a precursor mixture as a solvent-containing ceramic green-body. In further aspects, the solvent can comprise an aprotic solvent, for example, a polar aprotic solvent. Exemplary aspects of solvent include dimethyl carbonate, methyl ethyl ketone, toluene, anisole, dioxolane, methoxy propyl acetate, and combinations thereof. In aspects, a ratio of a weight of the solvent-free ceramic green-body to a weight of a solvent-containing ceramic green-body (e.g., as-formed) can be about 0.5 or more, about 0.55 or more, about 0.58 or more, about 0.7 or less, about 0.65 or less, or about 0.63 or less. In aspects, a ratio of a weight of the solvent-free ceramic green-body to a weight of a solvent-containing ceramic green-body (e.g., as-formed) can range from about 0.5 to about 0.7, from about 0.55 to about 0.65, from about 0.58 to about 0.63, or any range or subrange therebetween.

Table 1 presents exemplary ranges R1-R5 for the composition of the solvent-free ceramic green body (e.g., ceramic green-body 101) in accordance with the aspects discussed in the previous paragraph. Range R1 corresponds to the broadest range, and Ranges R2-R5 are subranges therein. Range R2 is free of a viscosity modifier. Ranges R1-R3 can be free of dispersant, and Ranges R1-R5 can comprise a dispersant. Range R5 provides the narrowest range of Ranges R1-R5. In aspects, all polymers in the binder system 113 may be carbonate-based polymers. In aspects, the binder system 113 can consist of a carbonate-based polymer, a alkali-metal containing ceramic particles, a dispersant, optionally a viscosity modifier, and optionally a solvent.

TABLE 1
Composition (wt %) of the solvent-free ceramic green-body

| Range | R1 | R2 | R3 | R4 | R5 |
|---|---|---|---|---|---|
| Carbonate-based | 5-20 | 5-20 | 10-20 | 5-20 | 10-20 |
| polymer | | | | | |
| Alkali-metal | 70-95 | 75-95 | 75-90 | 70-93 | 75-90 |
| containing ceramic | | | | | |
| particles | | | | | |
| Dispersant | 0-5 | 0-5 | 0-5 | 1-2 | 1-2 |
| Viscosity Modifier | 0-5 | 0 | 0-5 | 0-5 | 0-5 |

FIG. 2 illustrates a sintered article 201 comprising a first major surface 205 and a second major surface 207 opposite the first major surface 205. In aspects, the first major surface 205 and/or the second major surface 207 can extend along a corresponding plane, and/or the first major surface 205 can be substantially parallel to the second major surface 207. A sintered thickness 209 is defined as an average distance between the first major surface 205 and the second major surface 207. In aspects, the sintered thickness 209 can be within one or more of the ranges discussed above for the green-body thickness 109. The sintered article 201 comprises a sintered ceramic 211, for example, corresponding to the alkali-metal containing ceramic particles 111. Through the disclosure, “relative density” of a sintered article refers to a percentage of a maximum density obtained from a completed densified, pure material consisting of the same ceramic material. In aspects, the sintered article 201 can comprise a relative density of about 80% or more, about 85% or more, about 90% or more, about 92% or more, or about 95% or more.

In aspects, the sintered article can be an electrode as part of a battery. For example, the sintered article can be a cathode that is disposed on an electrolyte (e.g., solid-state electrolyte) that is in turn disposed on an anode to form a battery (e.g., solid-state battery). Alternatively, in aspects, the sintered article can be incorporated into a display device, for example, as a protective cover.

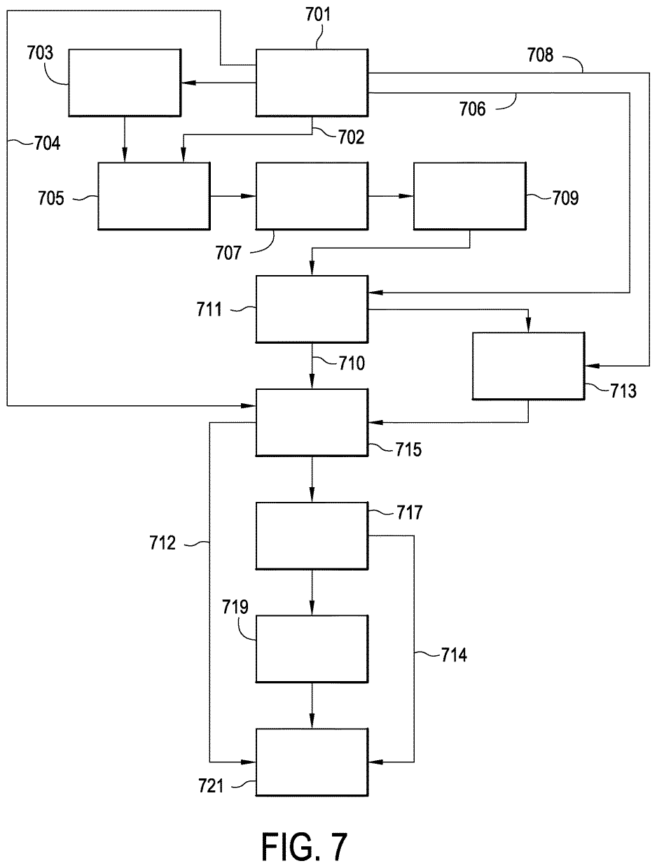

Aspects of methods of making the sintered article or a ceramic green-body in accordance with aspects of the disclosure will be discussed with reference to the flow chart in FIG. 7 and example method steps illustrated in FIGS. 3-6. In a first step 701, methods can start with obtaining alkali-metal containing ceramic particles, a carbonate-based polymer, a solvent, and optionally a dispersant and/or a viscosity modifier. In aspects, the alkali-metal containing ceramic particles can be provided by purchase or otherwise obtaining alkali-metal containing ceramic particles. In further aspects, the alkali-metal containing ceramic particles can be obtained by forming a glass that can be heat treated to form one or more ceramic crystals; then, the alkali-metal containing ceramic material can be milled to obtain particles of a predetermined particle size. In aspects, the carbonate-based polymer and/or the solvent can be provided by purchase or otherwise obtaining the carbonate-based polymer and/or solvent. Likewise, if obtained in step 701, the dispersant and/or the viscosity modifier can be provided by purchase or otherwise obtaining the dispersant and/or the viscosity modifier. In aspects, at the end of step 701, a ceramic green-body comprising the carbonate-based polymer and the alkali-metal containing ceramic particles can be formed or otherwise obtained, although in other aspects the ceramic green-body can be formed by following steps 703, 705, 707, 709, 711, and/or 713, as discussed below.

After step 701, as shown in FIG. 3, methods can proceed to step 703 comprising heating the alkali-metal containing ceramic particles 111 at a first temperature for a first period of time. In aspects, as shown in FIG. 3, heating the alkali-metal containing ceramic particles 111 can comprise placing the alkali-metal containing ceramic particles 111 in an oven 301 maintained at the first temperature for the first period of time. In aspects, the first temperature can be about 150 °C or more, about 300 °C or more, about 600 °C or more, or about 900 °C or more, about 1200 °C or less, about 1000 °C or less, about 700 °C or less, or about 250 °C or less, for example, ranging from about 150 °C to about 1200 °C, from about 600 °C to about 1000 °C, from about 900 °C to about 1000 °C, or any range or subrange therebetween. In aspects, first period of time can be about 1 minute or more, about 5 minutes or more, about 20 minutes or less, or about 10 minutes or less, for example, from about 1 minute to about 20 minutes, from about 5 minutes to about 10 minutes, or any range or subrange therebetween. Heating the alkali-metal containing ceramic particles before steps 703, 705, 707, and 709 (e.g., mixing and/or casting the ceramic green-body) can volatilize materials absorbed onto the alkali-metal containing ceramic particles and/or reduce an amount of alkali-metal at a surface of the alkali-metal containing ceramic particles.

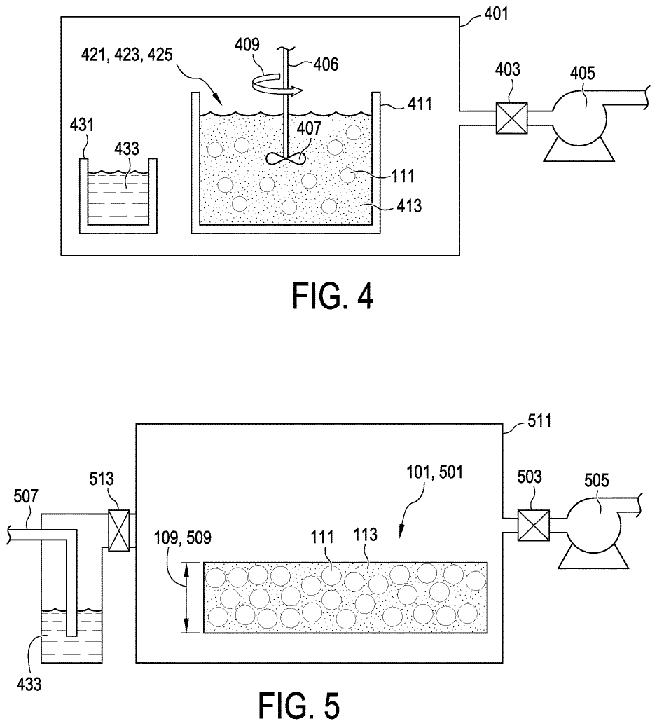

After step 701 or 703, as shown in FIG. 4, methods can proceed to step 705 comprising mixing the alkali-metal containing ceramic particles 111 with a solvent and optionally a dispersant to form a first mixture 421. In aspects, as shown in FIG. 4, the first mixture 421 can be mixed with an agitator 407 that is rotated 409 about a shaft 406 while the first mixture 421 containing a dispersive medium 413 is in a container 411. In aspects, step 705 can comprise mixing the materials for a second period of time of about 4 hours or more, about 12 hours or more, about 16 hours or more, about 1 day or more, about 30 days or less, about 4 days or less, or about 3 days or less. In aspects, step 705 can comprise mixing the materials for a second period of time ranging from about 4 hours to about 30 days, from about 12 hours to about 4 days, from about 16 hours to about 3 days, from about 1 day to about 3 days, or any range or subrange therebetween. In aspects, the mixing can occur at a second temperature of about 100 °C or less or about 60 °C or less, for example, from about 20 °C to about 100 °C, from about 25 °C to about 60 °C, from about 25 °C to about 40 °C, or any range or subrange therebetween. Mixing the alkali-metal containing ceramic particles with a solvent and optionally a dispersant (e.g., without additional materials) can provide a good dispersion of the alkali-metal containing ceramic particles in the solvent with few or no aggregates, which can improve a dispersion and/or distribution of the alkali-metal containing ceramic particles during subsequent steps. As discussed above, providing the dispersant can improve a dispersion and/or distribution of the alkali-metal containing ceramic particle and/or increase a period of time while the dispersion of the alkali-metal containing ceramic particles can be maintained.

After step 705, as shown in FIG. 4, methods can proceed to step 707 comprising mixing the first mixture 421 with the carbonate-based polymer and optionally a viscosity modifier to form a second mixture 423. In aspects, as shown in FIG. 4, the second mixture 423 can be mixed with the agitator 407 that is rotated 409 about the shaft 406 while the first mixture 421 containing the dispersive medium 413 is in a container 411. In aspects, step 707 can comprise mixing for a third period of time within one or more of the ranges discussed for the second period of time in step 705 in the previous paragraph, for example, from about 12 hours to about 3 days. In aspects, step 707 can comprise a third temperature within one or more of the ranges discussed for the second temperature in step 705 in the previous paragraph. As discussed above, the carbonate-based polymer can enable increased processing speed (e.g., faster debinding of the resulting ceramic green-body) and/or increased quality of the resulting sintered article. Providing the viscosity modifier can enable a predetermined viscosity of the second mixture to be obtained, which can enable casting the ceramic green-body while simultaneously enabling the ceramic green-body to be dimensionally stable.

After step 707, as shown in FIG. 4, methods can proceed to step 709 comprising deairing the second mixture to form a precursor mixture. In aspects, the deairing can comprise subjecting the second mixture to a reduced pressure environment for a third period of time. As used herein, a “reduced pressure environment” has an absolute pressure of less than 80 kiloPascals (kPa). In further aspects, the reduced pressure environment can comprise an absolute pressure in a range from about 1 kPa to about 80 kPa, from about 5 kPa to about 50 kPa, from about 10 kPa to about 30 kPa, or any range or subrange therebetween. In further aspects, the third period of time can be about 1 minute or more, about 5 minutes or more, about 30 minutes or less, or about 10 minutes or less, for example, from about 1 minute to about 30 minutes, from about 5 minutes to about 10 minutes, or any range or subrange therebetween. In further aspects, the reduced pressure environment can contain solvent corresponding to the solvent in the precursor mixture. In aspects, as shown in FIG. 4, the second mixture 423 in the container 411 is placed in a vacuum chamber 401 connected to a vacuum pump 405 through a valve 403, where the reduced pressure in the vacuum chamber 401 deairs the second mixture 423 to form the precursor mixture 425. In further aspects, as shown, another container 431 comprising a solvent 433 corresponding to the solvent of the second mixture 423 can also be within the vacuum chamber 401, for example, to reduce an evaporation of the solvent from the second mixture 423 during step 709. Providing a solvent-containing reduced pressure environment can reduce a loss of solvent from the second mixture during step 709. Providing a reduced pressure environment can reduce dissolved gasses in the second mixture to provide a precursor mixture that can be formed into a ceramic green-body with uniform, high-quality surfaces.

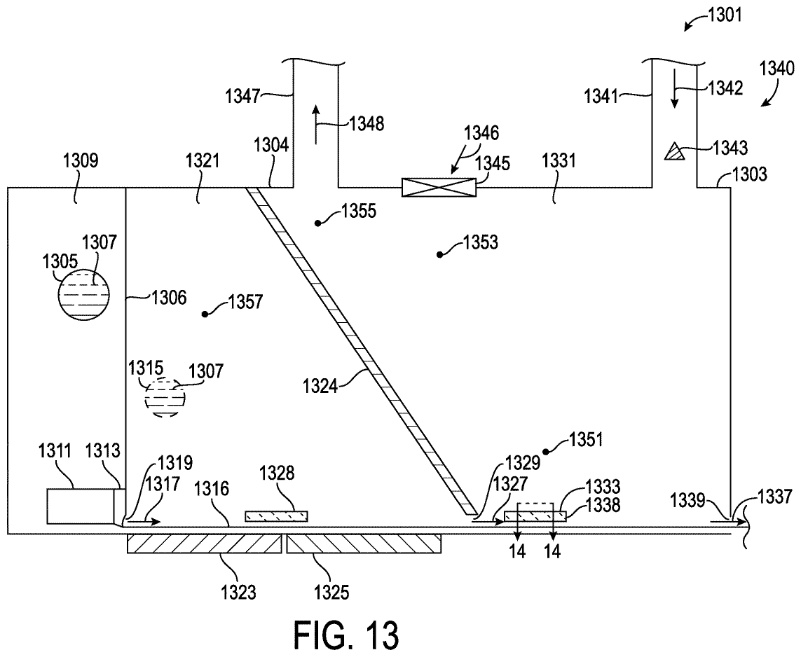

After step 701 or 709, as shown in FIG. 5, methods can proceed to step 711 comprising casting the precursor solution to form a solvent-containing ceramic green-body 501 comprising an initial thickness 509. In aspects, the initial thickness 509 can be within one or more of the ranges discussed above for the green-body thickness 109. The solvent-containing ceramic green-body 501 can comprise one or more of the details discussed above for the ceramic green-body 101 with reference to FIG. 1. In aspects, the solvent-containing ceramic green-body can be produced using the casting apparatus 1311 in the solvent-annealing apparatus 1301 discussed below with reference to FIG. 13.

After step 701 or 711, as shown in FIG. 5, methods can proceed to step 713 comprising solvent annealing the solvent-containing ceramic green-body 501 to form the ceramic green-body 101. As used herein, “solvent annealing” refers to controlling (i.e., decreasing) the rate at which solvent leaves the solvent-containing ceramic green-body by providing a moderate concentration of solvent in an environment around the solvent-containing ceramic green-body. In aspects, as shown in FIG. 5, the solvent-containing ceramic green-body 501 can be placed in a container 511 (e.g., vacuum chamber) with a controlled environment, where a concentration of solvent in the environment can be controlled (e.g., by valves 503 and 513). In further aspects, a concentration of solvent in the environment can be maintained and/or increased by opening the valve 513 to allow vapor from a reservoir of the solvent 433 that may be in liquid communication with a source of solvent by a conduit 507. Alternatively, the solvent reservoir may not be present during the solvent annealing. In further aspects, as shown, a concentration of solvent can be maintained and/or decreased by adjusting valve 503, which can be connected to a pump 505, which can also be used to control a pressure in the container 511. Alternatively, the solvent annealing can occur by covering the solvent-containing ceramic green-body with a material that is either semi-permeable to the solvent or impermeable to the solvent. At the end of step 713, the ceramic green-body 101 can comprise one or more of the aspects (e.g., compositions) discussed above for the ceramic green-body. In aspects, solvent annealing can occur for about 10 minutes or more, about 30 minutes or more, about 1 hour or more, about 2 hours or more, about 3 hours or more, about 24 hours or less, about 8 hours or less, about 5 hours or less, about 4 hours or less, about 2 hours or less, or about 1 hour or less, for example, from about 10 minutes to about 24 hours, from about 30 minutes hours to about 8 hours, from about 1 hour to about 8 hours, from about 2 hours to about 5 hours, from about 3 hours to about 4 hours, or any range or subrange therebetween. In aspects, the solvent-annealing can occur at about room temperature (i.e., 25 °C), for example from about 20 °C to about 30 °C. In aspects, the solvent-annealing can occur under reduced pressure corresponding to an absolute pressure of about 1 kiloPascal (kPa) or more, about 5 kPa or more, about 50 kPa or less, about 20 kPa or less, or about 10 kPa or less for example, from about 1 kPa to about 50 kPa, from about 5 kPa to about 20 kPa, from about 5 kPa to about 10 kPa, or any range or subrange therebetween. Using solvent annealing can produce a higher quality ceramic green-body with reduced defects that can be used to form a higher quality sintered article with reduced defects than would be obtained without solvent annealing. In aspects, solvent-annealing can occur as described below with reference to the solvent-laden chamber 1321 of the solvent-annealing apparatus 1301 shown in FIG. 13.

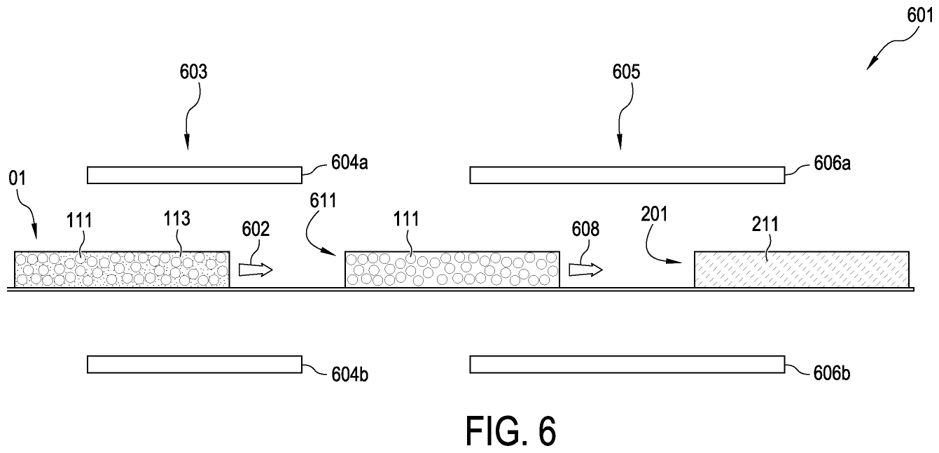

After step 701, 711, or 713, as shown in FIG. 6, methods can proceed to step 715 comprising heating the ceramic green-body 101 at a fifth temperature for a fifth period of time. In aspects, as shown, step 715 can comprise heating the ceramic green-body 101 using one or more heaters 604a and/or 604b (e.g., in a first oven 603). In further aspects, as shown, the ceramic green-body can be conveyed in a direction 602 past the one or more heaters 604a and/or 604b (e.g., through the first oven 603), which can enable continuous processing of the ceramic green-body 101. In aspects, the fifth temperature can be about 300 °C or less, about 280 °C or less, about 260 °C or less, about 250 °C or less, about 100 °C or more, about 150 °C or more, about 200 °C or more, or about 220 °C or more. In aspects, the fifth temperature can range from about 100 °C to about 300 °C, from about 150 °C to about 280 °C, from about 200 °C to about 260 °C, from about 220 °C to about 250 °C, or any range or subrange therebetween. For example, in step 715, a maximum temperature that the ceramic green-body 101 is heated at can be about 300 °C or less, about 280 °C or less, about 260 °C or less, or about 250 °C or less. In aspects, a temperature that the ceramic green-body 101 is heated at can increase as step 715 proceeds, for example linearly increasing or by increasing in successive temperature zones with corresponding predetermined temperatures. In aspects, the fifth period of time can be about 4 minutes or less, about 3 minutes or less, about 2 minutes or less, or about 1 minute or less, about 15 seconds or more, about 20 seconds or more, about 30 seconds or more, about 40 seconds or more, or about 1 minute or more. In aspects, the fifth period of time can range from about 15 seconds to about 5 minutes, from about 20 seconds to about 4 minutes, from about 20 seconds to about 3 minutes, from about 30 seconds to about 2 minutes, from about 40 seconds to about 1 minute, or any range or subrange therebetween. Step 715 is configured to remove organic material from the ceramic green-body to produce a debound ceramic article 611 (see FIG. 6) comprising the alkali-metal containing ceramic particles 111 and voids formed from the organic material removed in step 715. In aspects, step 715 can remove about 70 wt % or more, about 80 wt % or more, about 85 wt % or more, about 90 wt % or more, or about 95 wt % or more of organic materials in the ceramic green-body 101. Removing organic materials in step 715 can occur faster and/or at lower temperatures than otherwise possible due to the composition of the binder system 113 (e.g., carbonate-based polymer), as discussed herein. In particular, the binder system 113 in combination with the alkali-metal containing ceramic particles 111 can have reduced flammability than other materials for the binder system with the same alkali-metal containing ceramic particles, which can enable high-quality sintered articles to be formed and/or for organic material to be removed faster. Removing organic material faster can increase throughput and minimize resources (e.g., energy for heating, space for heating, time).

Throughout the disclosure, “heat flow” and “mass loss” is measured using thermo-gravimetric analysis and differential scanning calorimetry (DSC), respectively, with a heating rate of 10 °C/minute. As used herein, positive heat flow refers to exothermic behavior (i.e., heat released from the sample). In aspects, a maximum heat flow of the ceramic green-body from 25 °C to 300 °C can occur at a temperature of about 200 °C or more, about 230 °C or more, about 240 °C or more, about 300 °C or less, about 290 °C or less, or about 270 °C or less. In aspects, a maximum heat flow of the ceramic green-body from 25 °C to 300 °C can occur at a temperature ranging from about 200 °C to about 300 °C, from about 230 °C to about 290 °C, from about 240 °C to about 270 °C, or any range or subrange therebetween. In aspects, a maximum heat flow of the ceramic green-body from 25 °C to 300 °C in Watts emitted (exothermically) from the ceramic green-body at a temperature per gram of the ceramic green-body (W/g) can range from about 1 W/g to about 7 W/g, from about 3 W/g to about 6 W/g, or any range or subrange therebetween. In aspects, a maximum heat flow of the ceramic green-body from 25 °C to 300 °C in Watts emitted (exothermically) from the ceramic green-body per gram of polymer in the ceramic green-body (W/g) can be about 2.5 W/g or less, 2 W/g or less, about 1 W/g or more, or about 1.5 W/g or more, for example, from about 1 W/g to about 2.5 W/g, from about 1.5 W/g to about 2 W/g, or any range or subrange therebetween. Providing a reduced heat flow (e.g., about 7 W/g of the ceramic green-body or less, about 2 W/g of the polymer in the ceramic green-body) can reduce an incidence of defects introduced during step 715, for example from run-away thermal decomposition or flammability of the polymer decomposing, and/or enable faster processing of the ceramic green-body while maintaining high quality of the resulting sintered article.

After step 715, as shown in FIG. 6, methods can proceed to step 717 comprising heating at a sixth temperature for a sixth period of time. In aspects, as shown, the debound a debound ceramic article 611 can be heated by one or more heaters 606a and/or 606b (e.g., in a second oven 605) to form the sintered article 201 comprising the sintered ceramic 211. In further aspects, as shown, the debound ceramic article 611 can be conveyed in a direction 608 past the one or more heaters 606a and/or 606b (e.g., through the second oven 605), which can enable continuous processing to form the sintered article 201. In aspects, as shown in FIG. 6, a treatment apparatus 601 can comprise the first oven 603 and the second oven 605 in succession along a travel path that the ceramic green-body 101 travels along (see arrow 602 or direction 608). In further aspects, the first oven 603 can the second oven 605 can connect and/or be in close proximity to (e.g., abut) one another such that a temperature of the debound ceramic article 611 does not drop significantly (e.g., about 100 °C or less, about 50 °C or less), which can reduce energy costs, reduce processing time, and/or reduce space required for processing. Between the first oven 603 and the second oven 605, the temperature can drastically increase (e.g., by about 100 °C or more, about 300 °C or more, about 100 °C/minute or more or about 300 °C/minute or more). In aspects, the sixth temperature can be about 700 °C or more, about 800 °C or more, about 900 °C or more, about 1500 °C or less, about 1300 °C or less, or about 1100 °C or less. In aspects, the sixth temperature can range from about 700 °C to about 1500 °C, from about 800 °C to about 1300 °C, from about 900 °C to about 1100 °C, or any range or subrange therebetween. In aspects, the sixth period of time can be about 15 minutes or more, 30 minutes or more, about 45 minutes or more, about 1 hour or more, about 5 hours or less, about 3 hours or less, about 2 hours or less, about 1.5 hours or less, or about 1 hour or less. In aspects, the sixth period of time can range from about 15 minutes to about 5 hours, from about 30 minutes to about 3 hours, from about 45 minutes to about 2 hours, from about 1 hour to about 1.5 hours, or any range or subrange therebetween. Sintering the debound ceramic article 611 in step 717 can enable the debound ceramic article 611 to undergo densification and/or to gain mechanical strength. At the end of step 717, the sintered article 201 can comprise a relative density and/or a thickness within one or more of the corresponding ranges discussed above for the sintered article 201.

After step 717, methods can proceed to step 719 comprising assembling the sintered article in a composite article. In aspects, the sintered article can be an electrode as part of a battery. For example, the sintered article can be a cathode that is disposed on an electrolyte (e.g., solid-state electrolyte) that is in turn disposed on an anode to form a battery (e.g., solid-state battery). In aspects, the sintered article can be incorporated into a consumer electronic device (e.g., a display device), for example, as a protective cover.

After step 715, 717, or 719, methods can be complete upon reaching step 721. In aspects, methods of making a sintered article or a ceramic green-body in accordance with aspects of the disclosure can proceed along steps 701, 703, 705, 707, 709, 711, 713, 715, 717, 719, and 721 of the flow chart in FIG. 7 sequentially, as discussed above. In aspects, methods can follow arrow 702 from step 701 to step 705, for example, if the alkali-metal containing ceramic particles are not to be heated before mixing or the alkali-metal containing ceramic particles were already treated before the end of step 701. In aspects, methods can follow arrow 704 from step 701 to step 715, for example, if the alkali-metal containing ceramic particles are already part of a ceramic green-body that will not be subsequently subjected to solvent annealing by the end of step 701. In aspects, methods can follow arrow 706 from step 701 to step 711, for example, if the alkali-metal containing ceramic particles are in a precursor solution at the end of step 701. In aspects, methods can follow arrow 708 from step 701 to step 713, for example, if the alkali-metal containing ceramic particles are already part of a solvent-containing ceramic green-body and that ceramic green-body will be solvent annealed in step 713. In aspects, methods can follow arrow 710 from step 711 to step 715, for example, if the solvent-containing ceramic green-body is to be heated without first being solvent annealed. In aspects, methods can follow arrow 712 from step 715 to step 721, for example, if the methods are complete at the end of step 715. In aspects, methods can follow arrow 714 from step 717 to step 721, for example, if the methods are complete at the end of step 717. Any of the above options may be combined to make a sintered article or ceramic green-body in accordance with the embodiments of the disclosure.

FIG. 13 schematically illustrates a solvent-annealing apparatus 1301 in accordance with aspects of the disclosure. As shown, the solvent-annealing apparatus 1301 comprises a casting chamber 1309 including a casting apparatus 1311. The casting apparatus 1311 is configured to form a solvent-containing ceramic green-body 1328 from a precursor mixture (e.g., casting the precursor mixture to form the solvent-containing ceramic green-body). In aspects, as shown, the solvent-annealing apparatus 1301 can optionally include an adapter 1313 configured to transition the solvent-containing ceramic green-body from the casting apparatus 1311 to the conveyor 1316. In aspects, as shown, the casting chamber 1309 can be in fluid communication with a solvent reservoir 1305 configured to contain a solvent 1307. In further aspects, the solvent 1307 can correspond to one of the one or more solvents in the precursor mixture used to form the solvent-containing ceramic green-body. The solvent 1307 in the solvent reservoir 1305 can maintain a casting vapor pressure of the solvent in an environment of the casting chamber 1309. In further aspects, a chamber vapor pressure of the solvent in the casting chamber can be configured to be within one or more of the corresponding ranges discussed below with reference to methods of solvent-annealing.

As shown in FIG. 13, the solvent-annealing apparatus 1301 comprises a solvent-laden chamber 1321. In aspects, as shown, the solvent-laden chamber 1321 can be separated from the casting chamber 1309 by a baffle 1306. An orifice 1319 is provided therebetween and is configured to allow the solvent-containing ceramic green-body 1328 to pass therethrough, as indicated by arrow 1317. In aspects, as shown, the solvent-annealing apparatus 1301 can optionally include at least one additional source 1315 of solvent 1307, which is shown in another solvent reservoir 1305. The at least one additional source 1315 of solvent 1307, if present, comprises the same material as the solvent 1307. The at least one additional source 1315 of solvent 1307 can be configured to maintain a chamber vapor pressure of the solvent. Alternatively, the chamber vapor pressure can be maintained by the flow of solvent vapor from the casting chamber 1309 to the solvent-laden chamber 1321 (e.g., through the orifice 1319). In aspects, the chamber vapor pressure of the solvent in the solvent-laden chamber 1321 is configured to be less than a casting vapor pressure of the solvent in the casting chamber 1309. In further aspects, the chamber vapor pressure of the solvent in the casting chamber can be configured to be within one or more of the corresponding ranges discussed below with reference to methods of solvent-annealing. In aspects, as shown, the solvent-annealing apparatus 1301 can comprise one or more heating apparatus 1323 and/or 1325 configured to heat and/or maintain a chamber temperature of the solvent-laden chamber 1321. In further aspects, the chamber temperature of the solvent-laden chamber 1321 can be greater than a casting temperature of the casting chamber 1309. In further aspects, the chamber temperature can be within one or more of the corresponding ranges discussed below with reference to methods of solvent-annealing. In further aspects, a temperature encountered by a solvent-containing ceramic green-body 1328 transported along the conveyor 1326 in the direction indicated by arrow 1317 can increase. For example, a first heating apparatus 1323 can be configured to maintain a first temperature lower than a second temperature that the second heating apparatus 1325 is configured to be maintained. Although two heating apparatus 1323 and 1325 are shown, it is to be understood that more than two or only one heating apparatus can be provided in other aspects. Also, a rate that the conveyor 1316 transports the solvent-containing ceramic green-body 1328 through the solvent-laden chamber can be configured to be within one or more of the corresponding times discussed below with reference to methods of solvent-annealing. Also, it is to be understood that the solvent-laden chamber 1321 can resemble the apparatus shown in FIG. 5 and discussed above, in some aspects.

As shown in FIG. 13, the solvent-annealing apparatus 1301 comprises a drying chamber 1331. In aspects, as shown, the solvent-laden chamber 1321 can be separated from the drying chamber 1331 by a baffle 1324. As shown, the solvent-laden chamber 1321 is positioned between the casting chamber 1309 and the drying chamber 1331. Also, an orifice 1329 is provided through the baffle 1324 and is configured to allow the solvent-containing ceramic green-body 1328 to pass therethrough, as indicated by arrow 1327. In aspects, a drying vapor pressure of the solvent in the drying chamber 1331 is configured to be less than the chamber vapor pressure of the solvent in the solvent-laden chamber 1321. The drying chamber 1331 comprises a distal end 1303 opposite the baffle 1324, and the drying chamber 1331 comprises a proximate end 1303 proximate the baffle 1324 and opposite the distal end 1303. As shown by arrow 1327, the solvent-containing ceramic green-body 1328 is configured to be transported by the conveyor 1316 from the proximate end 1304 of the drying chamber 1331 to the distal end 1303 of the drying chamber 1331. As discussed below with reference to the partially dried ceramic green-body 1338, the substantially all of the solvent in the solvent-containing ceramic green-body 1328 can be removed to become a solvent-free ceramic green-body by the time that it travels through the outlet 1339 of the solvent-annealing apparatus 1301, as indicated by arrow 1337. In aspects, as discussed below, the solvent-annealing apparatus 1301 can be configured to feed the solvent-free ceramic green-body into the treatment apparatus 601 (see FIG. 6).

As shown in FIG. 13, the solvent-annealing apparatus 1301 comprise a ventilation system 1340. The ventilation system 1340 can be configured to circulate an atmosphere from a substantially solvent-free environment through the drying chamber 1331 (e.g., as indicated by arrows 1342, 1346, and/or 1348), for example, to remove solvent from the solvent-containing ceramic green-body 1328. As shown, the ventilation system 1340 can comprise a plurality of orifices (e.g., inlet 1341, air filter 1345, and/or outlet 1347). In aspects, as shown the ventilation system 1340 includes an inlet 1341 at a distal end 1303 of the drying chamber 1331 configured to introduce the atmosphere from the substantially solvent-free environment into the drying chamber 1331, as indicated by arrow 1342. In further aspects, a temperature of the atmosphere introduced by the inlet 1341 can comprise a predetermined temperature that can be achieved, for example, using a heating apparatus 1343. The predetermined temperature can correspond to a drying temperature of the drying chamber 1331 that can be greater than a chamber temperature of the solvent-laden chamber 1321. In aspects, the drying temperature can be within one or more of the corresponding ranges discussed below with reference to methods of solvent-annealing. As shown, the ventilation system 1340 includes an outlet 1347 at the proximate end 1304 of the drying chamber 1331 that is configured to remove the atmosphere at the proximate end 1304, as indicated by arrow 1348. Providing the inlet at the distal end and the outlet at the proximate end enables the atmosphere to flow in a direction opposite the direction (e.g., arrow 1327) that the solvent-containing ceramic green-body 1328 is transported, which can enable the atmosphere continuously remove solvent from the solvent-containing ceramic green body as the atmosphere flows by the solvent-containing ceramic green body and/or through the drying chamber. Additionally, providing the outlet at the proximate end of the drying chamber can enable the any solvent from the environment of the solvent-laden chamber that passes through the orifice 1329 to be removed. In aspects, as shown, the plurality of orifices can further comprise an additional orifice (e.g., air filter 1345) positioned between the proximate end 1304 and the distal end 1303 (e.g., between the outlet 1347 and the inlet 1341). In further aspects, as shown, the additional orifice (e.g., air filter 1345) can be configured to introduce additional atmosphere (e.g., substantially solvent-free environment) into the drying chamber 1331, as indicated by arrow 1346. For example, arrow 1346 indicates that atmosphere is introduced to the drying chamber 1331 through the air filter 1345, which can reduce particulate matter in the atmosphere that could otherwise impair a surface quality of the resulting solvent-free ceramic green-body and/or sintered article. Although not shown, it is to be understood that the substantially solvent-free atmosphere introduced through the inlet 1341 can also be filtered (e.g., HEPA) and/or comprise a low level of particulates (e.g., satisfying one or more clean room standards for atmosphere). Introducing atmosphere at both the distal end and at another location (between the distal end and the proximate end) can facilitate removal of solvent from the solvent-containing ceramic green-body at a predetermined rate.

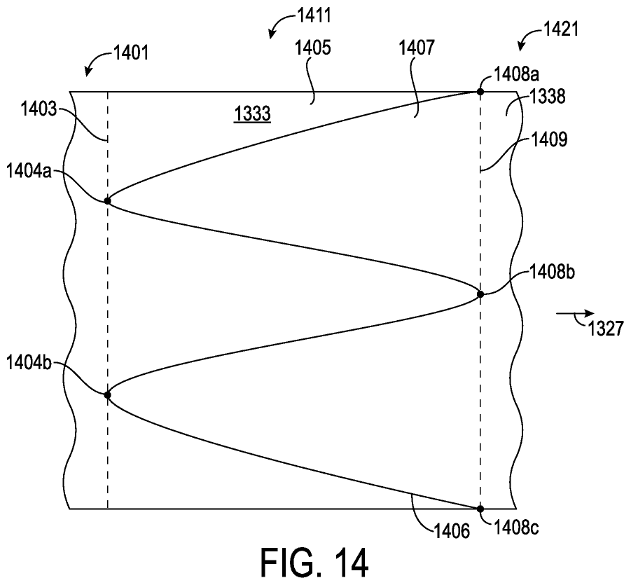

Aspects of methods of solvent annealing will now be discussed with reference to the solvent-annealing apparatus 1301 schematically illustrated in FIG. 13 and the partially dried ceramic green-body 1338 illustrated in FIG. 14. Methods can include casting the precursor solution to form a solvent-containing ceramic green-body 1328 in the casting chamber 1309. In aspects, the precursor solution can comprise a composition within one or more of the corresponding ranges discussed above. In aspects, the casting can correspond to step 711 discussed above and/or comprise any one or more of the aspects discussed above (e.g., composition, thickness). In aspects, the casting chamber 1309 can comprise a casting vapor pressure of a solvent corresponding to a solvent in the solvent-containing ceramic green-body 1328. In further aspects, the casting vapor pressure can be about 100 Pascals or more, about 500 Pascals or more, about 1,000 Pascals or more, about 5,000 Pascals or more, about 10,000 Pascals or more, about 20,000 Pascals or more, about 30,000 Pascals or more, about 40,000 Pascals or more, about 50,000 Pascals or more, about 60,000 Pascals or more, or within 10,000 Pascals of a vapor pressure of the solvent at its boiling point. In further aspects, the casting vapor pressure can be in a range from about 100 Pascals to about 50,000 Pascals, from about 500 Pascals to about 50,000 Pascals, from about 1,000 Pascals to about 50,000 Pascals, from about 5,000 Pascals to about 40,000 Pascals, from about 10,000 Pascals to about 30,000 Pascals, from about 20,000 Pascals to about 30,000 Pascals, or any range or subrange therebetween. As discussed above, the casting vapor pressure can be maintained and/or provided by solvent 1307 from a solvent reservoir 1305 in fluid communication with the casting chamber 1309. The solvent reservoir 1305 can be maintained a reservoir temperature that is greater than a casting temperature of the casting chamber 1309, which can facilitate volatilization of the solvent from the solvent reservoir. For example, the reservoir temperature can be about 50 °C or more, about 60 °C or more, about 65 °C or more, about 70 °C or more, about 75 °C or more, about 80 °C or more, about 95 °C or less, about 90 °C or less, about 85 °C or less, or about 80 °C or less. In aspects, the reservoir temperature can be in a range from about 50 °C to about 95 °C, from about 55 °C to about 90 °C, from about 60 °C to about 85 °C, from about 65 °C to about 80 °C, from about 70 °C to about 80 °C, or any range or subrange therebetween. In aspects, the casting vapor pressure can correspond to a vapor pressure of one or more of propylene glycol, methyl ethyl ketone, dimethyl carbonate, toluene, or combinations thereof. In further aspects, the casting vapor pressure can correspond to a vapor pressure of a single solvent, and that solvent can be the same as a solvent in the composition of the solvent-containing ceramic green-body 1328. Providing the casting vapor pressure (e.g., about 100 Pascals or more, from about 1,000 Pascals to about 50,000 Pascals) can limit an amount of solvent evaporating from the solvent-containing ceramic green-body during casting and/or in the casting chamber, which can be associated with a good surface quality of the resulting solvent-free ceramic green-body and/or sintered article.

After casting the solvent-containing ceramic green-body 1328 (e.g., in the casting chamber 1309), as shown in FIG. 13, the solvent-containing ceramic green-body 1328 can be transporting to the solvent-laden chamber 1321 for solvent annealing, for example, by being transported by the conveyor 1316 through the orifice 1319 (as indicated by arrow 1317). In aspects, the solvent annealing in the solvent-laden chamber 1321 can correspond to step 713 discussed above. In aspects, a chamber vapor pressure of the solvent in the solvent-laden chamber 1321 can be less than the casting vapor pressure of the solvent in the casting chamber 1309. In further aspects, the chamber vapor pressure can be maintained through one or more of atmosphere comprising the casting vapor pressure entering the solvent-laden chamber 1321 (e.g., through orifice 1319), volatilization of solvent from the optional, additional source 1315 of solvent 1307, the controlled rate of solvent leaving the solvent-containing ceramic green-body 1328, and combinations thereof. In further aspects, the additional source 1315 of solvent 1307 may not be maintained at a separate temperature (unlike solvent reservoir 1305), and/or the additional source 1315 of solvent 1307 can comprise one or more containers (e.g., dishes) for the condensation and re-evaporation of the solvent 1307 in the solvent-laden chamber 1321.

In further aspects, the chamber vapor pressure can be about 20 Pascals or more, about 50 Pascals or more, about 100 Pascals or more, about 500 Pascals or more, about 1,000 Pascals or more, about 5,000 Pascals or more, about 10,000 Pascals or more, about 20,000 Pascals or more, about 50,000 Pascals or less, about 40,000 Pascals or less, about 30,000 Pascals or less, about 20,000 Pascals or less, about 10,000 Pascals or less, or about 8,000 Pascals or less. In further aspects, the chamber vapor pressure can be in a range from about 20 Pascals to about 50,000 Pascals, from about 50 Pascals to about 50,000 Pascals, 100 Pascals to about 50,000 Pascals, from about 500 Pascals to about 50,000 Pascals, from about 1,000 Pascals to about 50,000 Pascals, from about 5,000 Pascals to about 40,000 Pascals, from about 10,000 Pascals to about 30,000 Pascals, from about 20,000 Pascals to about 30,000 Pascals, or any range or subrange therebetween. Providing the chamber vapor pressure (e.g., about 20 Pascals or more, from about 1,000 Pascals to about 50,000 Pascals, and/or less than the casting vapor pressure) can facilitate the controlled removal of solvent from the solvent-containing ceramic green-body.

In aspects, a chamber temperature of the solvent-laden chamber 1321 can be greater than a casting temperature of the casting chamber 1309. In further aspects, the chamber temperature of the solvent-laden chamber 1321 can be about 40 °C or more, about 50 °C or more, about 60 °C or more, about 65 °C or more, about 70 °C or more, for example, in a range from about 40 °C to about 100 °C, from about 50 °C to about 90 °C, from about 60 °C to about 80 °C, or any range or subrange therebetween. As shown in FIG. 13, one or more heating apparatus 1323 and/or 1325 can heat the solvent-laden chamber 1321 and/or the solvent-containing ceramic green-body 1328 being transported therethrough. In further aspects, the one or more heating apparatus 1323 and/or 1325 can generate multiple heating zones an132d/or a temperature gradient in the solvent-laden chamber 1321 such that the temperature encountered by the solvent-containing ceramic green-body 1328 increases as it is transported through solvent-laden chamber 1321 (e.g., in the direction indicated by arrow 1317). Providing an increasing temperature encountered by the solvent-containing ceramic green-body being transported through the solvent-laden ceramic green-body can facilitate the controlled and continuous removal of solvent from solvent-laden ceramic green-body as part of the solvent-annealing process. In aspects, a time that the solvent-containing ceramic green-body 1328 spends in the solvent-laden chamber 1321 (e.g., time being heated in the solvent-laden chamber) can be about 3 minutes or more, about 4 minutes or more, about 5 minutes or more, about 6 minutes or more, about 8 minutes or more, about 10 minutes or more, about 30 minutes or less, about 20 minutes or less, about 10 minutes or less, about 9 minutes or less, about 8 minutes or less, about 7 minutes or less, about 6 minutes or less, or about 5 minutes or less. In aspects, the time that the solvent-containing ceramic green-body 1328 spends in the solvent-laden chamber 1321 (e.g., time being heated in the solvent-laden chamber) can be in a range from about 3 minutes to about 30 minutes, from about 3 minutes to about 20 minutes, from about 3 minutes to about 10 minutes, from about 4 minutes to about 9 minutes, from about 5 minutes to about 8 minutes, from about 6 minutes to about 7 minutes, or any range or subrange therebetween.

In aspects, after transporting the solvent-containing ceramic green-body 1328 through the solvent-laden chamber 1321, as shown in FIG. 13, methods can comprise transporting the solvent-containing ceramic green-body 1328 to the drying chamber 1331, for example, on the conveyor 1316 through the orifice 1329 as indicated by arrow 1327. In further aspects, a drying vapor pressure of the solvent in the drying chamber 1331 can be less than the chamber vapor pressure and the casting vapor pressure. In further aspects, the drying vapor pressure can be about 20 Pascals or less, about 15 Pascals or less, about 10 Pascals or less, about 5 Pascals or less, or about 1 Pascal or less. Providing a drying vapor pressure less of about 20 Pascals or less can facilitate the removal of solvent from the solvent-containing ceramic green-body to form the solvent-free ceramic green-body. In further aspects, the drying chamber 1331 can be maintained at a drying temperature that is greater than the casting temperature and the chamber temperature. In further aspects, the drying temperature can be within about 20 °C, within 15 °C, or within about 10 °C of a boiling point of the solvent. In further aspects, the chamber temperature can be about 70 °C or more, about 75 °C or more, about 80 °C or more, about 85 °C or more, about 90 °C or more, about 130 °C or less, about 110 °C or less, about 100 °C or less, or about 90 °C or less. In further aspects, the chamber temperature can be in a range from about 70 °C to about 130 °C, from about 75 °C to about 110 °C, from about 80 °C to about 100 °C, from about 85 °C to about 90 °C, or any range or subrange therebetween. In further aspects, as shown in FIG. 13, the drying temperature can be maintained by heating the atmosphere and/or solvent-containing ceramic green body in the drying chamber with a heating apparatus 1343. In even further aspects, the heating can occur by heating an atmosphere introduced to the drying chamber 1331 from a substantially solvent-free environment by flowing the atmosphere around the heating apparatus 1343, for example, positioned in the inlet 1341 although the heating apparatus can be positioned in other locations in other aspects.

In aspects, as shown in FIG. 13, drying the solvent-containing ceramic green-body can comprise introducing an atmosphere from a substantially solvent-free environment into the drying chamber 1331. In further aspects, as shown, the atmosphere can be introduced through the inlet 1341 (as indicated by arrow 1342), which can be positioned at the distal end 1303 of the drying chamber. Additionally, as shown, atmosphere can be removed from the drying chamber through an outlet 1347 (as indicated by arrow 1348) positioned at the proximate end 1304 of the drying chamber 1331. Providing the inlet at the distal end and the outlet at the proximate end enables the atmosphere to flow in a direction opposite the direction (e.g., arrow 1327) that the solvent-containing ceramic green-body 1328 is transported, which can enable the atmosphere continuously remove solvent from the solvent-containing ceramic green body as the atmosphere flows by the solvent-containing ceramic green body and/or through the drying chamber. Additionally, providing the outlet at the proximate end of the drying chamber can enable the any solvent from the environment of the solvent-laden chamber that passes through the orifice 1329 to be removed. In further aspects, atmosphere can be introduced from the substantially solvent-free environment at a plurality of locations, including the inlet 1341 at the distal end 1303 and at an additional location (e.g., air filter 1345, as indicated by arrow 1346) at a location between the distal end 1303 and the proximate end 1304 and/or between the inlet 1341 and the outlet 1347. Introducing atmosphere at both the distal end and at another location (between the distal end and the proximate end) can facilitate removal of solvent from the solvent-containing ceramic green-body at a predetermined rate. In further aspects, an average speed of atmosphere over the solvent-containing ceramic green-body in the drying chamber 1331 (e.g., as measured at location 1351) can be about 0.1 meters per second (m/s), about 0.08 m/s, about 0.05 m/s, about 0.03 m/s, about 0.02 m/s, about 0.01 m/s, or about 0.01 m/s or more, for example, in a range from about 0.01 m/s to about 0.1 m/s, from about 0.01 m/s to about 0.08 m/s, from about 0.01 m/s to about 0.05 m/s, from about 0.01 m/s to about 0.03 m/s, from about 0.01 m/s to about 0.02 m/s, or any range or subrange therebetween. Providing a low average speed of atmosphere (e.g., about 0.1 m/s or less, or from about 0.01 m/s to about 0.1 m/s) over the solvent-containing ceramic green body can facilitate uniform drying and/or good surface quality of the resulting solvent-free ceramic green-body and/or resulting sintered article. The average speed of atmosphere over the solvent-containing ceramic green-body can be less than an average speed of atmosphere at other locations in the drying chamber (e.g., location 1353 near the additional source of atmosphere between the distal end 1303 and the proximate end 1304, or location 1355 near the outlet 1347 at the proximate end 1304), which can facilitate high surface quality of the resulting article while exchanging larger amounts of atmosphere through the drying chamber 1331 to keep the chamber vapor pressure low.

FIG. 14 shows a first major surface 1333 of a partially dried ceramic green-body 1338 in the drying chamber 1331 (see FIG. 13) comprised a solvent-containing portion 1401 and a solvent-free portion 1421 with a boundary 1406 therebetween. As shown, the boundary 1406 varies between extrema 1408a, 1408b, and 1408c at a solvent-free threshold 1409 and opposing extrema 1404a and 1404b at the solvent-containing threshold 1403 with the solvent-free threshold 1409 downstream from the solvent-containing threshold 1403, as indicated by arrow 1327. As shown, the partially dried ceramic green-body 1338 can comprise a dried portion 1407 comprising two regions between the solvent-free threshold 1409 and the solvent-containing threshold 1403. The location of the solvent-free threshold 1409, the solvent-containing threshold 1403, and the distance therebetween can be controlled by the drying vapor pressure, the drying temperature, and the average speed of atmosphere over the solvent-containing ceramic green-body. When the solvent-containing ceramic green-body is dried too quickly, surface defects can be formed in the resulting solvent-free ceramic green-body, for example, by drying a segment at the surface before surrounding portions of the ceramic green-body, which can cause the segment to separate from the bulk of the ceramic green-body.

### EXAMPLES

Various aspects will be further clarified by the following examples. Examples 1-14 and Comparative Examples AA-CC were analyzed via TGA and DSC, as described above. Examples 1-3 and Comparative Example AA were polymers without alkali-metal containing ceramic particles. Examples 4-14 and Comparative Examples BB-CC were ceramic green-bodies comprising lithium cobalt oxide (LCO) particles with a median particle size of 0.45 μm as the alkali-metal containing ceramic particles. In Examples 1, 4, 6-7, and 11, the polymer was poly(butylene carbonate) (PBC). In Examples 2, 5, 9, and 12-13, the polymer was poly(propylene carbonate) (PPC). In Example 3, the polymer was a linear, random copolymer, namely, poly(propylene-co-cyclohexene carbonate) (PPCC). In Example 10, the polymer was 50 wt % PBC and 50 wt % PPC. In Example 14, the polymer was a combination of PBC and PPC (see Table 3). In Comparative Examples AA-BB, the polymer was poly(vinyl butyral) (PVB). In Comparative Example CC, the polymer was a blend of 95 wt % PBC and 5 wt % poly(methyl methacrylate) (PMMA) (PBC/PMMA). As used in the Examples, the PVB had a molecular weight Mn of 100,000 Da, the PPC had a molecular weight Mn of 120,000 Da, the PBC had a molecular weight Mn of 200,000 Da, and the PPCC had a molecular weight of 250,000 Da.

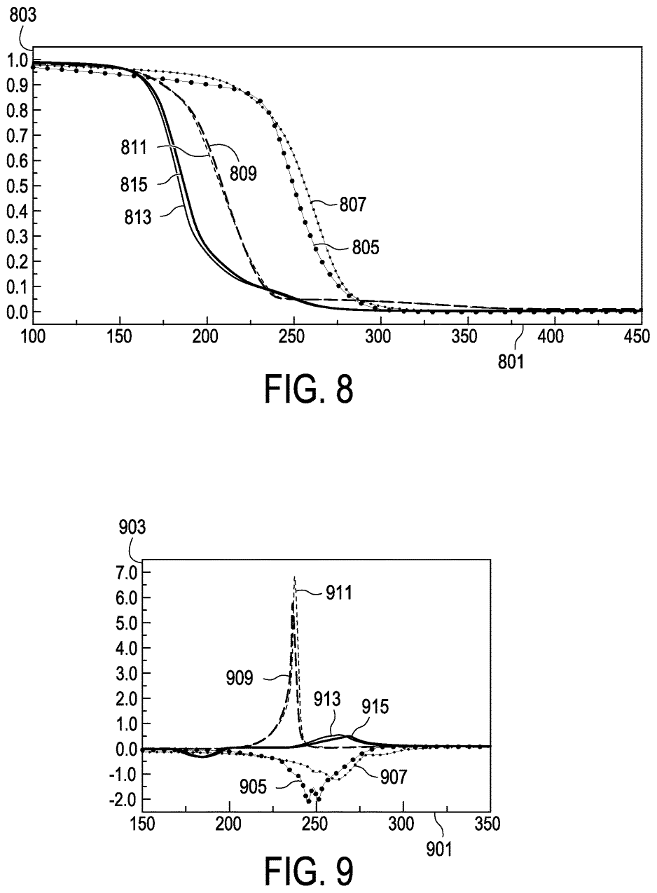

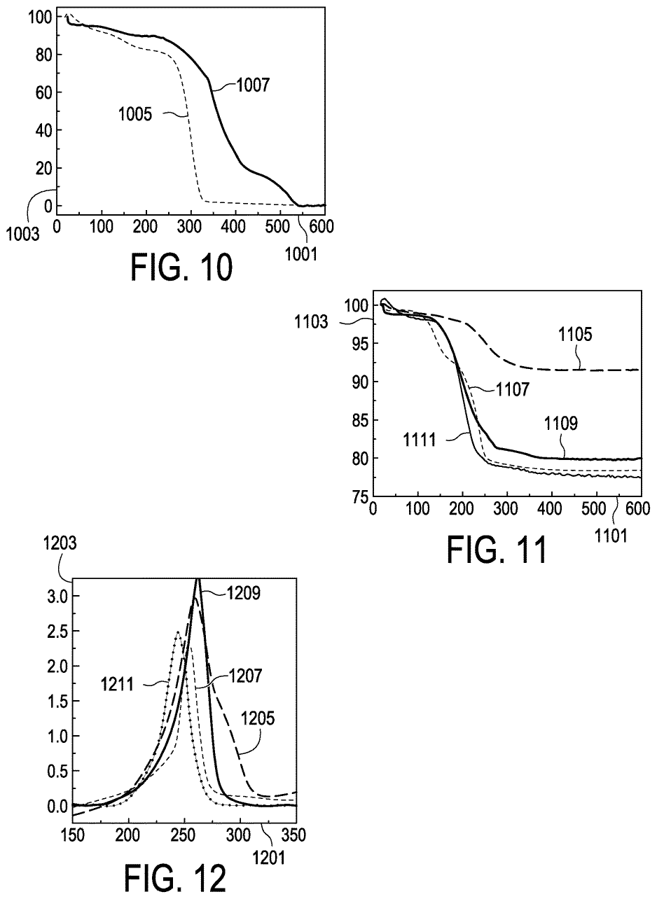

FIGS. 8 and 10-11 show mass-loss curves from TGA. In FIGS. 8 and 10-11, the horizontal axis 801, 1001, or 1101 is the temperature in °C. In FIG. 8, the vertical axis 803 is the fraction of the original mass remaining. In FIG. 8, curves 805, 807, 809, 811, 813, and 815 are mass-loss curves showing the fraction of the original mass remaining at a given temperature and correspond to Examples 1-2 and 4-7, respectively. In FIGS. 10-11, the vertical axis 1003 or 1103 is the percentage of the original mass remaining. In FIG. 10, curves 1005 and 1007 are mass-loss curves showing the percentage of the original mass remaining at a given temperature and correspond to Example 3 and Comparative Example AA, respectively. In FIG. 11, curves 1105, 1107, 1109, and 1111 are mass-loss curves showing the percentage of the original mass remaining at a given temperature and correspond to Comparative Example BB, Comparative Example CC, Example 8, and Example 10, respectively.

FIGS. 9 and 12 show heat flow from DSC. In FIGS. 9 and 12, the horizontal axis 901 or 1201 is the temperature in °C, and the vertical axis 903 or 1203 is heat flow in W/g with positive values corresponding to exothermic heat flow (i.e., heat emitted from the sample). In FIG. 9, the heat flow is per mass of the ceramic green-body; however, in FIG. 12, the heat flow is per mass of the polymer in the ceramic green-body. In FIG. 9, curves 905, 907, 909, 911, 913, and 915 are heat-flow curves showing the heat-flow from the sample at a given temperature and correspond to Examples 1-2 and 4-7, respectively. In FIG. 12, curves 1205, 1207, 1209, and 1211 are heat-flow curves showing the heat-flow from the sample at a given temperature and correspond to Comparative Example BB, Example 8, Comparative Example CC, and Example 10 respectively.

FIG. 10 shows mass-loss curves for Example 3 (PPCC) and Comparative Example A (PVB). Curve 1007 shows that Comparative Example A undergoes mass-loss in multiple, distinct processes based on changes in the slope around 150 °C, around 200 °C, around 350 °C, and from 400 °C to 500 °C. Also, curve 1007 suggests that PVB would not be completely removed from a ceramic green-body until 500 °C or more. In contrast, curve 1005 suggests that virtually all of the PPCC (Example 3) would be removed from a ceramic green-body at temperatures less than 350 °C. Also, curve 1005 more evenly loses more mass between 50 °C and 250 °C than curve 1007. In FIG. 8, curves 805 and 807 are mass-loss curves for Examples 1-2, respectively. Curves 805 and 807 suggest that virtually all of the PBC (Example 1) and PPC (Example 2) would be removed at temperatures less than 300 °C.

In FIG. 9, curves 905 and 907 show heat-flow curves for Examples 1-2. Curves 905 and 907 show significant endothermal (negative heat flow) from about 200 °C to about 300 °C. The endothermic (i.e., heat absorbed by the sample) behavior on heating of Examples 1-2 indicates that PBC and PPC are undergoing depolymerization rather than chain scission. As discussed above, it is believed that carbonate-based polymers and acrylate-based (e.g., methacrylate-based) polymers can decompose by depolymerization. The endothermic depolymerization of PBC and PPC suggests that they would reduce an incidence of run-away heating since the depolymerization absorbs heat rather than releasing heat, which can enable increased heating rates without impacting the quality of the resulting sintered article.

Table 2 presents the compositions of Examples 4-10 and Comparative Examples BB-CC. Dibutyl phthalate (DBP) and poly(ethylene glycol) 400 (PEG) are viscosity modifiers. KD1 and KD73 are from the Hypermer line of dispersants (available from Croda Energy Technologies). Fish oil is a dispersant. Dibutyl maleate (DBM) is a plasticizer. Unless otherwise indicated, the LCO particles were heated at 150 °C for 2 hours before being mixed with the other components in Table 2. For Examples 6-7, the LCO particles were heated at 900 °C in water-laden air for 5 minutes or 10 minutes, respectively, as discussed below with reference to FIGS. 8-9. Ceramic green-bodies were cast with a doctor blade, where a precursor solution comprised the compositions in Table 2 mixed with solvent, where the compositions in Table 2 represented about 60 wt % of the precursor solution.

TABLE 2
Composition (wt %) of Examples (Ex) 4-10
and Comparative Examples (CE) BB-CC

| | Exs 4, 6-7 | Ex 5 | Ex 8 | Ex 9 | Ex 10 | CE BB | CE CC |
|---|---|---|---|---|---|---|---|
| LCO | 80 | 80 | 80 | 80 | 80 | 93.1 | 80 |
| PBC | 18.8 | | | | 8.5 | | |
| PPC | | 15 | | 16.9 | 8.5 | | |
| PPCC | | | 12.5 | | | | |
| PVB | | | | | | 4.3 | |
| PBC/PMMA | | | | | | | 15 |
| DBM | | | 6.3 | | | | |
| DBP | | 3.8 | | 1.9 | 0.9 | 1.3 | 3.8 |
| PEG | | | | | 0.9 | | |
| KD1 | | 1.2 | | | | 1.3 | |
| KD73 | 1.2 | | | 1.2 | 1.2 | | 1.2 |
| Fish Oil | | | 1.2 | | | | |

FIG. 11 shows mass-loss curves for Comparative Example BB, Comparative Example CC, Example 8, and Example 10. Curve 1105 is a mass-loss curve for Comparative Example BB, which shows less mass loss at higher temperatures compared to curve 1007 (e.g., about 75 °C lower), which suggests that the alkali-metal containing ceramic particles (LCO) catalyze the decomposition of the PVB. Likewise, curve 1107 shows that the mass loss occurs at lower temperatures. For example, curves 1107, 1109, and 1111 (Example 8, Example 10, and Comparative Example CC) have similar shapes and indicate that more than 70%, more than 80%, or more than 90% (e.g., substantially all) of organic materials are removed before 300 °C.

FIG. 12 shows heat-flow curves for Comparative Example BB, Comparative Example CC, Example 8, and Example 10. The heat flow in FIG. 12 is per mass of polymer included in the ceramic green-body. Curves 1205, 1207, 1209, and 1211 show exothermic heat flows in the shown temperature range. Curve 1209 (Comparative Example CC) shows the greatest exothermic heat flow (e.g., greater than 3 W/g). Compared to curve 1211 (Example 10), curve 1209 (Comparative Example CC) has a greater maximum heat flow and this maximum occurs at a higher temperature. This demonstrates that even 5 wt % PMMA added in Comparative Example CC greatly increases the maximum heat flow. Despite the ability of methacrylate-based polymers to decompose by depolymerization, FIG. 12 demonstrates that the PMMA (a methacrylate-based polymer) exothermically decomposes (e.g., by chain scission), which greatly increases the maximum heat flow and increases the risk of run-away decomposition, flammability, and/or surface defects being formed while heating the ceramic green-body relative to Example 10. As shown in FIG. 12, curve 1209 (Comparative Example CC) comprises a maximum heat flow of more than 3 W/g and curve 1205 (Comparative Example BB) comprises a maximum heat flow of about 3 W/g while curves 1207 and 1211 (Examples 8 and 10) comprise maximum heat flows of about 2.5 W/g or less. The lower maximum heat flow of Examples 8 and 10 can enable faster processing (e.g., heating) of a ceramic green-body while maintaining a high-quality, resulting sintered article, for example with less risk of run-away decomposition, flammability, and/or surface defects. Curves 1207 and 1211 (Examples 8 and 10) have the lowest heat flow, and curve 1207 (Example 8) has its maximum heat flow at the lowest temperature of the curves shown in FIG. 12.

Curves 809 and 811 in FIG. 8 correspond to mass-loss curves for Examples 4-5, respectively. As noted above with reference to FIG. 11, the alkali-metal containing ceramic particles (LCO) decreases the temperature where the greatest mass loss occurs, for example shifting from about 250 °C to about 275 °C in curves 805 and 807 to about 200 °C in curves 809 and 811 (e.g., about 75 °C lower). Curves 909 and 911 in FIG. 9 correspond to heat-flow curves for Examples 4-5, respectively. Unlike in FIG. 12, the heat flow reported in FIG. 9 is per mass of the entire ceramic green-body. As shown, curves 909 and 911 are exothermic with maximum heat flow around 230 °C. Compared to curves 905 and 907, curves 909 and 911 reach an extremum at lower temperature (e.g., 235 °C versus about 245 °C to about 250 °C) and are exothermic (instead of endothermic). The exothermic heat flow is attributed to the alkali-metal containing ceramic particles catalyzing more chain scission (exothermic) than is observed for the homopolymer. Curve 909 (Example 4; PBC) has a lower maximum heat flow than curve 911 (Example 5; PPC) even though the corresponding mass-loss curves 809 and 811 in FIG. 8 look substantially the same. As demonstrated above in FIG. 12, the PBC polymer (curve 1211) has a lower maximum heat flow than an acrylate-containing polymer (PBC/PMMA; curve 1209) and the PVB polymer (curve 1205).

For Examples 6-7, the LCO particles were heated at 900 °C for 5 minutes or 10 minutes, respectively, instead of the 150 °C for 2 hours as in Examples 4-5. The high-temperature treatment in Examples 6-7 is believed to reduce a surface concentration of alkali-metal on the LCO particles as some of the alkali-metal volatilizes during the treatment. As shown in FIG. 8, curves 813 and 815 (Examples 6-7) lost mass at lower temperatures than any of the other curves in FIG. 8. However, as shown in FIG. 9, curves 913 and 915 (Examples 6-7) have an endothermic peak heat flow of about −0.5 W/g at from about 180 °C to about 190 °C followed by a maximum exothermic heat flow of about 1 W/g or less at from about 260 °C to about 270 °C. Compared to curves 909 and 911, the heat flow is reduced by nearly an order of magnitude for curves 913 and 915. The endothermic peak for curves 913 and 915 is associated with depolymerization. It is believed that the reduced but non-zero alkali content of the LCO particles (of Examples 6-7 with the 900 °C treatment compared to Examples 4-5 with the 150 °C treatment) may catalyze the depolymerization reaction at lower temperatures than the chain scission reaction. The low exothermic peak for 913 and 915 presents a significantly decreased risk for issues with heating the ceramic green-body.

Table 3 shows the composition and maximum firing speed that could be used to obtain defect-free fired ribbons. The heating apparatus comprises a first oven with a length of 50 centimeters (cm) with a temperature with multiple zones with set temperatures that approximately linearly ramps the temperature from about 100 °C to a maximum temperature of about 280 °C along its length connected to a second oven with a length of about 500 cm operated at temperatures from about 1000 °C to about 1300 °C along its length. Samples of Examples 11-14 and Comparative Example BB comprising a length of 12 cm and a width of 3.5 cm were placed on an alumina substrate that was conveyed by a pair of air bearings through the ovens at a predetermined speed. Predetermined speeds of 2.1 millimeters per second (mm/s), 4.2 mm/s, 6.3 mm/s, 8.4 mm/s, 12.6 mm/s, 16.8 mm/s and 21.0 mm/s were tested. Example 11 had the same composition as Example 4. In Table 3, PC refers to propylene carbonate, which was used as a plasticizer. Example 14 used LCO particles that had been heated at 900 °C in water-laden air for 5 minutes.

As shown in Table 3, Comparative Example BB had a maximum speed of 2.1 mm/s. At higher speeds, Comparative Example BB combusted between the first oven and the second oven. Examples 11-14 achieved speeds greater than 5 mm/s and greater than 8 mm/s. Example 13 had a maximum speed of 8.4 mm/s. Further, Examples 11-12 and 14 achieved speeds greater than 10 mm/s and 12 mm/s (corresponding to treatment times in the first oven of 1 minute or less, or about 40 seconds or less). Examples 11-12 achieved maximum speeds of 12.6 mm/s. Example 14 worked at the highest speed tested of 21 mm/s (corresponding to a treatment time in the first oven of 24 seconds), which is 10 times faster than the maximum speed for Comparative Example BB. Examples 11-14 demonstrate that using a carbonate-based polymer can enable faster processing while producing high-quality sintered articles. Further, combinations of carbonate-based polymers and/or combinations of plasticizers can enable further increases in processing rates. It is unexpected that faster speeds (relative to Comparative Example BB) can be achieved using Examples 11-14 given the higher organic content (e.g., 3-4 times more polymer) to be removed.

TABLE 3
Composition (wt %) and Maximum Speed for Examples
(Ex) 11-14 and Comparative Examples (CE) BB

| | Ex 11 | Ex 12 | Ex 13 | Ex 14 | CE BB |
|---|---|---|---|---|---|
| Max Speed; | 12.6; 40 | 12.6; 40 | 8.4; 60 | 21.0; 24 | 2.1; 240 |
| Time | | | | | |
| (mm/s; sec) | | | | | |
| LCO | 80 | 80 | 80 | 80 | 93.1 |
| PBC | 18.8 | | | 8.5 | |
| PPC | | 15 | | 8.5 | |
| PPCC | | | 15 | | |
| PVB | | | | | 4.3 |
| DBP | | | 3.8 | 0.9 | 1.3 |
| PEG | | | | 0.9 | |
| PC | | 3.8 | | | |
| KD1 | | 1.2 | 12 | | 1.3 |
| KD73 | 1.2 | | | 1.2 | |

A solvent-annealing apparatus resembling the solvent-annealing apparatus 1301 shown in FIG. 13 was constructed and the average speed of atmosphere at locations 1351, 1353, and 1355 and in the solvent-laden chamber was measured. The average speed of atmosphere in the solvent-laden chamber was less than 0.1 m/s. The average speed of atmosphere at location 1351 (i.e., of atmosphere flowing over the solvent-containing ceramic green-body in the drying chamber) was also less than 0.1. The average speed of atmosphere at location 1353 (i.e., near the additional inlet between the proximate end and the distal end) was about 0.7 m/s. The average speed of atmosphere at location 1355 (i.e., near the outlet) was about 1 m/s. Consequently, the solvent-laden apparatus can provide a low average speed of atmosphere over the solvent-containing ceramic green-body relative to the average speed at other locations in the drying chamber. Examples with the compositions of Examples 4-10 were produced using the solvent-annealing apparatus and produced high quality solvent-free ceramic green-bodies.

The above observations can be combined to provide a ceramic green-body comprising a carbonate-based polymer, a sintered article formed from the ceramic-green body, and methods of making the same. Providing a carbonate-based polymer can enable faster processing of the resulting ceramic green-body to form the sintered article, for example, by decreasing the incidence of events during heating the green-body that can impair the quality of the sintered article. For example, the carbonate-based polymer can provide reduced flammability during heating of the ceramic green-body. Flammability is associated with relatively large molecular weights (e.g., 200 Daltons or more) corresponding to multiple monomers bonded together, which can be produced during heating, for example, as a result of decomposition by chain scission. Without wishing to be bound by theory, carbonate-based polymers and acrylate-based (e.g., methacrylate-based) polymers can decompose by depolymerization in addition to chain scission while other polymers only decompose by chain scission. However, as demonstrated in the Examples above, in the presence of alkali-metal containing ceramic particles, it has unexpectedly been found that methacrylate-based polymers predominantly decompose by chain scission while carbonate-based polymers predominantly decompose by depolymerization. Without wishing to be bound by theory, alkali-metal containing ceramic particles can present issues for debinding (i.e., removing organic components of the green-body) in a short period of time (e.g., about 4 minutes or less) because the alkali metals can catalyze chain scission of components (e.g., polymers) of the binder system that can be flammable, which can damage the ceramic and/or the resulting sintered article. Providing a reduced heat flow (e.g., about 7 W/g of the ceramic green-body or less, about 2 W/g of the polymer in the ceramic green-body) can reduce an incidence of defects introduced during heating, for example from run-away thermal decomposition or flammability of the polymer decomposing, and/or enable faster processing of the ceramic green-body while maintaining high quality of the resulting sintered article.

Heating the alkali-metal containing ceramic particles before mixing and/or casting the ceramic green-body can volatilize materials absorbed onto the alkali-metal containing ceramic particles and/or reduce an amount of alkali-metal at a surface of the alkali-metal containing ceramic particles. Mixing the alkali-metal containing ceramic particles with a solvent and optionally a dispersant (e.g., without additional materials) can provide a good dispersion of the alkali-metal containing ceramic particles in the solvent with few or no aggregates, which can improve a dispersion and/or distribution of the alkali-metal containing ceramic particles during subsequent steps of the methods. As discussed above, providing the dispersant can improve a dispersion and/or distribution of the alkali-metal containing ceramic particle and/or increase a period of time while the dispersion of the alkali-metal containing ceramic particles can be maintained. The carbonate-based polymer can enable increased processing speed (e.g., faster debinding of the resulting ceramic green-body) and/or increased quality of the resulting sintered article. Providing the viscosity modifier can enable a predetermined viscosity of the second mixture to be obtained, which can enable casting the ceramic green-body while simultaneously enabling the ceramic green-body to be dimensionally stable. Providing a solvent-containing reduced pressure environment can reduce a loss of solvent from the second mixture during deairing to form the precursor mixture. Providing a reduced pressure environment can reduce dissolved gasses in the second mixture to provide a precursor mixture that can be formed into a ceramic green-body with uniform, high-quality surfaces. Using solvent annealing can produce a higher quality ceramic green-body with reduced defects that can be used to form a higher quality sintered article with reduced defects than would be obtained without solvent annealing. In aspects, the first oven 603 can the second oven 605 can connect and/or abut one another such that a temperature of the debound ceramic article 611 does not drop significantly (e.g., about 100 °C or less, about 50 °C or less), which can reduce energy costs, reduce processing time, and/or reduce space required for processing.

The present disclosure also presents a solvent-annealing apparatus including a solvent-laden chamber configured to control a rate of solvent removal from the solvent-containing ceramic green-body. Using solvent annealing can produce a higher quality ceramic green-body with reduced defects that can be used to form a higher quality sintered article with reduced defects than would be obtained without solvent annealing. Providing a casting vapor pressure (e.g., about 100 Pascals or more, from about 1,000 Pascals to about 50,000 Pascals, and/or within 10,000 Pascals of the vapor pressure at the boiling point of the solvent) of solvent in a casting chamber can limit an amount of solvent evaporating from the solvent-containing ceramic green-body during casting and/or in the casting chamber, which can be associated with a good surface quality of the resulting solvent-free ceramic green-body and/or sintered article. Providing a chamber vapor pressure (e.g., about 20 Pascals or more, from about 1,000 Pascals to about 50,000 Pascals, and/or less than the casting vapor pressure) of the solvent in the solvent-laden chamber can facilitate the controlled removal of solvent from the solvent-containing ceramic green-body. Providing an increasing temperature encountered by the solvent-containing ceramic green-body being transported through the solvent-laden ceramic green-body can facilitate the controlled and continuous removal of solvent from solvent-laden ceramic green-body as part of the solvent-annealing process. Providing a drying vapor pressure less of about 20 Pascals or less in the drying chamber can facilitate the removal of solvent from the solvent-containing ceramic green-body to form the solvent-free ceramic green-body. Providing an inlet at the distal end and an outlet at the proximate end of the drying chamber enables the atmosphere to flow in a direction opposite the direction that the solvent-containing ceramic green-body is transported, which can enable the atmosphere continuously remove solvent from the solvent-containing ceramic green body as the atmosphere flows by the solvent-containing ceramic green body and/or through the drying chamber. Additionally, providing the outlet at the proximate end of the drying chamber can enable the any solvent from the environment of the solvent-laden chamber that passes through the orifice 1329 to be removed. Introducing atmosphere at both the distal end and at another location (between the distal end and the proximate end) can facilitate removal of solvent from the solvent-containing ceramic green-body at a predetermined rate. Providing a low average speed of atmosphere (e.g., about 0.1 m/s or less, or from about 0.01 m/s to about 0.1 m/s) over the solvent-containing ceramic green body can facilitate uniform drying and/or good surface quality of the resulting solvent-free ceramic green-body and/or resulting sintered article. The average speed of atmosphere over the solvent-containing ceramic green-body can be less than an average speed of atmosphere at other locations in the drying chamber, which can facilitate high surface quality of the resulting article while exchanging larger amounts of atmosphere through the drying chamber 1331 to keep the chamber vapor pressure low.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1.-7. (canceled)

8. A method of forming a sintered article:
heating a ceramic green-body at a maximum temperature of about 300 °C or less for a first period of time of about 4 minutes or less, the heating removes about 70 wt % or more of organic materials in the ceramic green-body; and then
sintering the ceramic green-body at a second temperature from about 700 °C to about 1500 °C for a second period of time from about 30 minutes to about 5 hours to form the sintered article, the sintered article comprising a relative density of about 90% or more of a theoretical density,
wherein the ceramic green-body comprises a carbonate-based polymer and alkali-metal containing ceramic particles.

9. The method of claim 8, wherein the heating removes about 90% or more of organic materials in the ceramic green-body.

10. The method of claim 8, wherein the maximum temperature is about 260 °C or less and the first period of time is about 1 minute or less.

11. The method of claim 8, wherein a maximum heat flow from the ceramic green-body during the heating, in Watts per gram of a polymer in the ceramic green-body (W/g), is about 2 W/g or less.

12. The method of claim 8, wherein the ceramic green-body, as a wt % of a solvent-free ceramic green-body, comprising:
from about 5 wt % to about 20 wt % of the carbonate-based polymer;
from about 70 wt % to about 95 wt % of the alkali-metal containing ceramic particles;
from 0 wt % to about 5 wt % of a dispersant; and
from 0 wt % to about 5 wt % of a viscosity modifier.

13. The method of claim 8, further comprising:
casting a solvent-containing ceramic green-body from a precursor mixture, the casting occurs in a casting chamber comprising a casting vapor pressure of about 100 Pascals or more of a solvent in the solvent-containing ceramic green-body;
transporting the solvent-containing ceramic green-body from the casting chamber to a solvent-laden chamber, the solvent-laden chamber comprising a chamber vapor pressure of the solvent in the solvent-laden chamber is about 20 Pascals or more, the casting vapor pressure is greater than or equal to the casting vapor pressure;
heating the solvent-containing ceramic green-body at a chamber temperature of the solvent-laden chamber of about 40 °C or more, the chamber temperature of the solvent-laden chamber is greater than a temperature of the casting chamber;
transporting the solvent-containing ceramic green-body from the solvent-laden chamber to a drying chamber, the chamber vapor pressure is greater than a drying vapor pressure of the solvent in the drying chamber; and
heating the solvent-containing ceramic green-body at a drying temperature of the drying chamber to form a solvent-free ceramic green-body corresponding to the ceramic green-body, the drying temperature is greater than the chamber temperature.

14. The method of claim 13, wherein the casting vapor pressure is maintained by solvent reservoir of the solvent in fluid communication with the casting chamber, heating the solvent reservoir at a reservoir temperature greater than a casting temperature of the casting chamber.

15. The method of claim 13, wherein the casting vapor pressure is from about 1,000 Pascals to about 50,000 Pascals.

16. The method of claim 13, wherein the heating the solvent-containing ceramic green-body at the chamber temperature of the solvent-laden chamber occurs for from about 3 minutes to about 10 minutes.

17. The method of claim 13, further comprising introducing an atmosphere from a substantially solvent-free environment into the drying chamber at least at a distal end and removing the atmosphere from the drying chamber at a proximate end at an interface between the solvent-laden chamber and the drying chamber, and the proximate chamber opposite the distal end.

18. The method of claim 17, wherein an average speed of the atmosphere over the solvent-containing ceramic green-body in the drying chamber is from about 0.01 meter per second to about 0.1 meters per second.

19. The method of claim 17, wherein the introducing the atmosphere occurs at the distal end and at least an additional location between the distal end and the proximate end.

20. The method of claim 13, wherein the solvent comprises propylene glycol, methyl ethyl ketone, dimethyl carbonate, toluene, or combinations thereof.

21. A solvent-annealing apparatus comprising:
a casting chamber comprising a casting apparatus configured to form a solvent-containing ceramic green-body from a precursor mixture, the casting chamber in fluid communication with a solvent reservoir;
a solvent-laden chamber comprising at least one heating apparatus configured to maintain a temperature of the solvent-laden chamber; and
a drying chamber comprising a ventilation system configured to circulate an atmosphere from a substantially solvent-free environment through the drying chamber,
wherein the solvent-laden chamber positioned between the casting chamber and the drying chamber, the solvent-laden chamber separated from the drying chamber by a baffle.

22. The solvent-annealing apparatus of claim 21, wherein a casting vapor pressure in the casting chamber of a solvent in the solvent-containing ceramic green-body is configured to be greater than or equal to a chamber vapor pressure in the solvent-laden chamber of the solvent, and the chamber vapor pressure is configured to be greater than a drying vapor pressure of the solvent in the drying chamber.

23. The solvent-annealing apparatus of claim 21, wherein the ventilation system is configured to introduce the atmosphere from the substantially solvent-free environment at least at a distal end of the drying chamber opposite a proximate end of the drying chamber with the baffle, and the ventilation system is configured to remove the atmosphere from the drying chamber at the proximate end of the drying chamber.

24. The solvent-annealing apparatus of claim 23, wherein the drying chamber comprises a plurality of orifices, the plurality of orifices comprising a first orifice at the distal end of the drying chamber and at least an additional orifice between the distal end and the proximate end, the first orifice and the at least the additional orifice configured to introduce the atmosphere from the substantially solvent-free environment.

25. A ceramic green-body, as a wt % of a solvent-free ceramic green-body, comprising:
from about 5 wt % to about 20 wt % of a carbonate-based polymer;
from about 70 wt % to about 95 wt % of alkali-metal containing ceramic particles;
from 0 wt % to about 5 wt % of a dispersant; and
from 0 wt % to about 5 wt % of a viscosity modifier,
wherein the alkali-metal containing ceramic particles are lithium-containing ceramic particles.

26. The ceramic green-body of claim 25, wherein the carbonate-based polymer consists of alkyl carbonate esters.

27. The ceramic green-body of any one of claim 25, wherein a median particle size of the alkali-metal containing ceramic particles is about 0.5 micrometers or less.
